(19) United States
(12) Patent Application Publication
(10) Pub. No.: US 2026/0072240 A1
(43) Pub. Date: Mar. 12, 2026

(54) LENS APPARATUS AND SYSTEM HAVING THE SAME

(71) Applicant: CANON KABUSHIKI KAISHA, Tokyo (JP)

(72) Inventors: DAISAKU NAGAHAMA, Tochigi (JP); KEI KINOSHITA, Saitama (JP)

(21) Appl. No.: 19/302,492

(22) Filed: Aug. 18, 2025

(30) Foreign Application Priority Data
Sep. 10, 2024 (JP) 2024-156748
Jun. 24, 2025 (JP) 2025-106204

(51) Int. Cl. G02B 7/16; G03B 17/12

(52) U.S. Cl. CPC G02B 7/16; G03B 17/12

(57) ABSTRACT

Lens apparatuses and systems are provided herein. One or more lens apparatuses may include a plurality of optical areas configured to be selectively inserted into or removed from an optical path, one or more processors that, upon execution of instructions, operate to acquire information on a plurality of optical characteristics corresponding to the plurality of optical areas, and determine an optical area among the plurality of optical areas using the information, and a driver configured to insert the determined optical area into the optical path.

### BACKGROUND

### Field of the Technology The aspect of the disclosure relates to one or more embodiments of a lens apparatus and a system having the same.

### Description of the Related Art

In some conventional lens apparatuses, an optical unit can be inserted into and removed from an optical path (see Japanese Patent Application Laid-Open No. 2023-102671). In other configurations, a plurality of optical units have different magnifications and can be switched when the magnification is specified.

### SUMMARY

One or more embodiments of a lens apparatus according to one or more aspects of the disclosure may include a plurality of optical areas configured to be selectively inserted into or removed from an optical path, one or more processors that, upon execution of instructions, operate to acquire information on a plurality of optical characteristics corresponding to the plurality of optical areas, and determine an optical area among the plurality of optical areas using the information, and a driver configured to insert the determined optical area into the optical path. One or more embodiments of a lens apparatus according to one or more aspects of the disclosure may include a plurality of optical areas configured to be selectively inserted into or removed from an optical path. The plurality of optical areas include first and second optical areas having the same optical characteristic and different imaging magnifications, and third and fourth optical areas having different optical characteristics other than the imaging magnifications from those of the first and second optical areas and different imaging magnifications from each other. One or more embodiments of a lens apparatus according to one or more aspects of the disclosure may include a plurality of optical areas configured to be selectively inserted into or removed from an optical path, one or more processors that, upon execution of instructions, operate to acquire information on aberrations of the plurality of optical areas, and determine an optical area among the plurality of optical areas using the information, and a driver configured to insert the determined optical area into the optical path. One or more systems may include one or more lens apparatuses in accordance with one or more other aspects of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration diagram of a camera system according to Example 1.

FIG. 2 illustrates one example of a driven unit according to Example 1.

FIG. 3 illustrates another example of the driven unit according to Example 1.

FIG. 4 illustrates an example of an optical unit (optical area) included in the driven unit according to Example 1.

FIG. 5 is a flowchart illustrating optical-unit switching processing according to Example 1.

FIG. 6 is a flowchart illustrating optical-unit switching processing according to Example 2.

FIG. 7 is a flowchart illustrating the optical-unit switching processing according to Example 2.

FIG. 8 is a flowchart illustrating optical-unit switching processing according to Example 3.

FIG. 9 is a flowchart illustrating optical-unit switching processing according to Example 4.

FIG. 10 is a configuration diagram of a camera system according to Example 5.

FIG. 11 is a schematic diagram of an optical-area switching apparatus according to Example 5.

FIG. 12 is an optical-area clockwise (CW)/counterclockwise (CCW) switching flowchart according to Example 5.

FIG. 13 is a configuration diagram of a camera system according to Example 6.

FIG. 14 is a schematic diagram of an optical-area switching apparatus according to Example 6.

FIG. 15 is an optical-characteristic switching flowchart according to Example 6.

FIG. 16 is a schematic diagram supplementing the operation of the optical-characteristic switching flowchart according to Example 6.

FIG. 17 is an imaging-magnification switching flowchart according to Example 6.

FIG. 18 is a schematic diagram supplementing the operation of the imaging-magnification switching flowchart according to Example 6.

FIG. 19 is a switching flowchart in switching to a target optical area via another optical area according to Example 6.

FIG. 20 is a schematic diagram supplementing the switching operation in a first mode according to Example 6.

FIG. 21 is a schematic diagram supplementing the switching operation in a second mode according to Example 6.

FIG. 22 is a schematic diagram supplementing the switching operation in a third mode according to Example 6.

FIG. 23 is a schematic diagram supplementing the switching operation in a fourth mode according to Example 6.

FIG. 24 is a mode setting flowchart using a memory according to Example 6.

FIG. 25 is a switching flowchart to an initial optical area to be used after Example 6 starts.

FIG. 26 is a schematic diagram supplementing the switching operation in a first initial setting according to Example 6.

FIG. 27 is a schematic diagram supplementing the switching operation in a third initial setting according to Example 6.

FIG. 28 is an initial setting flowchart using the memory according to Example 6.

FIG. 29 is a configuration diagram of a camera system according to Example 7.

FIG. 30 is a schematic diagram of an optical-area switching apparatus according to Example 7.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

### EXAMPLE 1

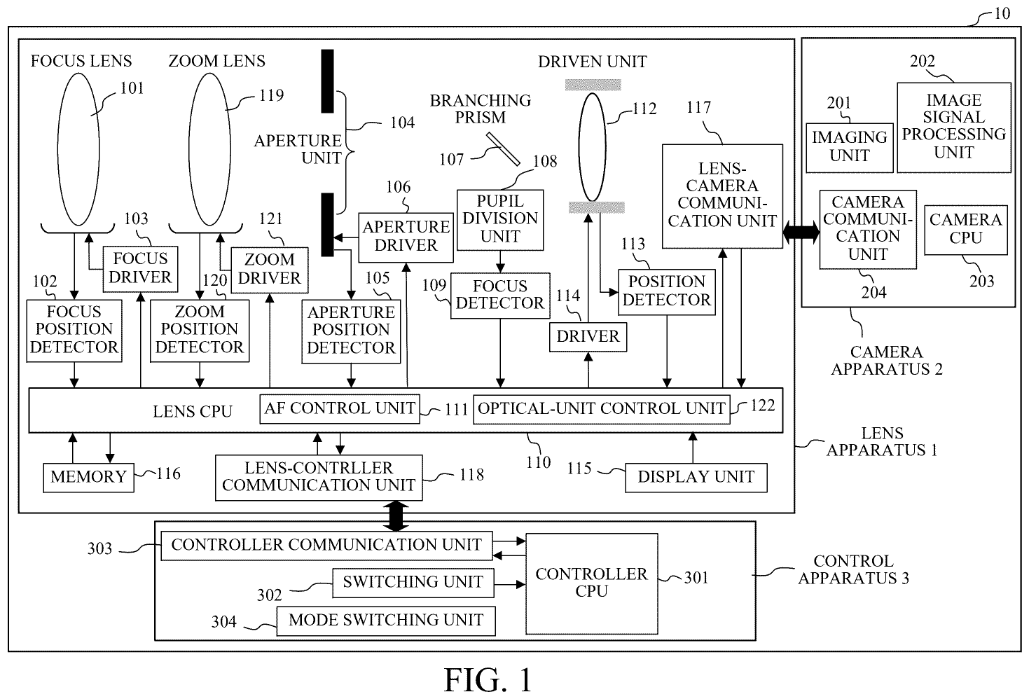

FIG. 1 is a configuration diagram of a camera system (imaging system) 10 according to this example. The camera system 10 includes a lens apparatus 1, a camera apparatus (image pickup apparatus) 2 attachable to and detachable from the lens apparatus 1, and a control apparatus (external apparatus) 3. However, the camera system 10 is not limited to this configuration, and may consist of the lens apparatus 1 and a camera apparatus 2. The lens apparatus 1 and the camera apparatus 2 may be integrated, or the lens apparatus 1 and the control apparatus 3 may be integrated.

A focus lens 101 is disposed on the optical axis. Adjusting the position of the focus lens 101 along the optical axis direction enables an object to be focused. A focus position detector 102 and a focus driver 103 are mechanically connected to the focus lens 101, and a known encoder and motor for position detection in this example, respectively.

An aperture (mechanism) unit 104 includes an aperture stop (diaphragm) disposed on the optical axis. The aperture unit 104 can adjust a light amount from the object by adjusting the aperture stop. An aperture mechanism position detector 105 and an aperture driver 106 are mechanically connected to the aperture unit 104, and are a known encoder and motor for position detection in this example.

A branching prism 107 branches a part of the light from the object. That is, the branching prism 107 branches the light that has passed through the focus lens 101 into first light that travels toward a driven unit 112 and second light to be used for autofocusing.

A pupil division unit 108 divides the second light branched by the branching prism 107 into two light beams for phase-difference AF control. A focus detector 109 forms two images using the pair of light beams split by the pupil division unit 108, and calculates an evaluation value for AF control from a phase difference between the two images. The smaller the phase difference is, the higher the evaluation value is.

The lens CPU 110 is a control unit for the lens apparatus 1. The lens CPU 110 obtains current position information on the focus lens 101 and the aperture unit 104 from the focus position detector 102 and the aperture position detector 105, respectively. The lens CPU 110 then issues commands to the focus driver 103 and the aperture unit 104, and controls the driving of the focus lens 101 and the aperture unit 104 to target positions.

The AF control unit 111 is provided inside the lens CPU 110, and determines whether or not the optical system is in focus from an evaluation value calculated by the focus detector 109. In a defocus (out-of-focus) state, the AF control unit 111 can calculate a defocus amount required to transition to an in-focus state using the evaluation value and current position information on the focus lens 101.

A zoom lens 119 is disposed on the optical axis. A focal length can be adjusted by adjusting the position of the zoom lens 119 along the optical axis. This adjustment can set an angle of view. A zoom position detector 120 and a zoom lens driver 121 are mechanically connected to the zoom lens 119, and are a known encoder and motor for position detection in this example.

The driven unit 112 includes a plurality of optical units. By rotationally driving (rotating) the driven unit 112, the plurality of optical units are inserted into and removed from the optical path. Each of the plurality of optical units has a plurality of optical characteristics including a first optical characteristic and a second optical characteristic. The plurality of optical units include a first optical unit and a second optical unit that have the same first optical characteristic but different second optical characteristics. In the following description, the driven unit 112 includes a magnification-varying lens as an example of an optical unit, but the disclosure is not limited to this example. The optical unit may have a characteristic that affects the lens apparatus 1. The driven unit 112 in this example is rotatable about an axis in the same direction as the optical axis of the lens apparatus.

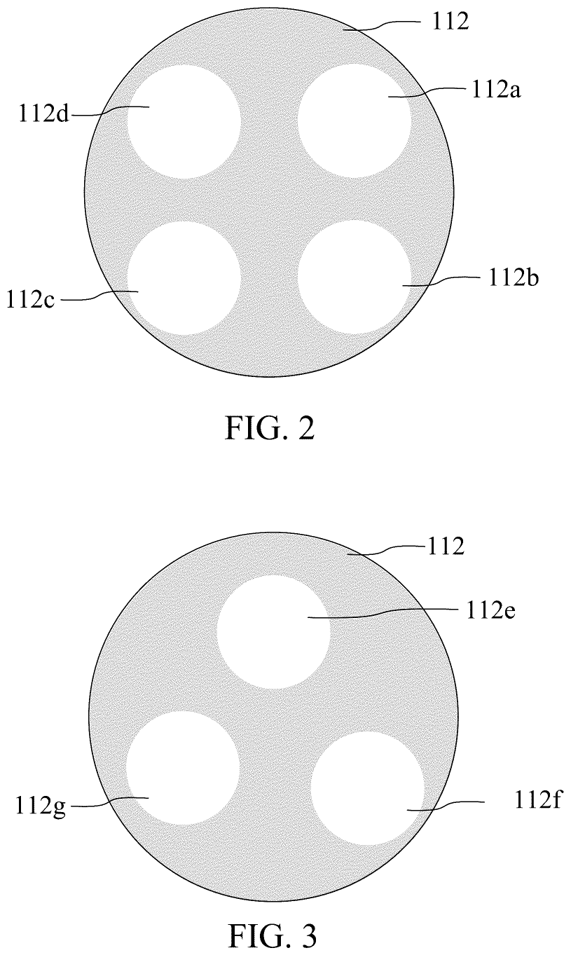

FIG. 2 illustrates an example of the driven unit 112. The driven unit 112 in this example includes optical units 112a, 112b, 112c, and 112d. The number of optical units included in the driven unit 112 is not limited to four as long as it is two or more. For example, the driven unit 112 may include three optical units 112e, 112f, and 112g as illustrated in FIG. 3.

The optical units may include a normal lens, which is a magnification-varying lens intended only to change the magnification, and a soft focus lens (cinema lens), which is a magnification-varying lens intended to change the magnification and aberration. The soft focus lens can give a blurred feeling like a cinematic image by changing the aberration. In other words, in a case where the soft focus lens is inserted into the optical path, an object can be captured with a soft atmosphere while being focused on the object. Here, changing the aberration means intentionally producing, for example, spherical aberration or chromatic aberration. Changing the magnification means varying the magnification of the optical system that does not involve the driven unit 112, and the magnifications of the magnification-varying lens and the soft focus lens may be the same.

The disclosure is not limited to this example, and may intentionally produce a variety of aberrations other than spherical aberration and chromatic aberration. In order to provide the object with a better effect, at least one of spherical aberration and chromatic aberration may be provided. In this example, the soft focus lens will be described as intentionally producing spherical aberration.

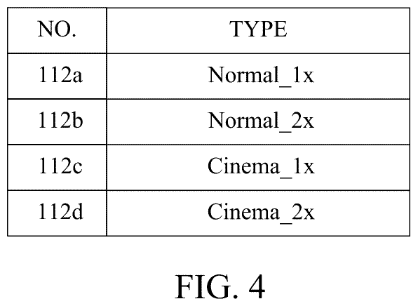

For example, in a case where the driven unit 112 includes optical units 112a, 112b, 112c, and 112d as illustrated in FIG. 2, it is assumed that the optical units 112a, 112b, 112c, and 112d are the types of lenses illustrated in FIG. 4. In FIG. 4, the optical units 112a and 112b are normal lenses, and the optical units 112c and 112d are soft focus lenses. The optical units 112a and 112c have a magnification of 1× (times), and the optical units 112b and 112d have a magnification of 2×. That is, the optical unit 112a is a normal lens with a magnification of 1× (hereinafter, normal_1×). The optical unit 112b is a normal lens with a magnification of 1× (hereinafter, normal_2×). The optical unit 112c is a soft focus lens with a magnification of 1× (hereinafter, cinema_1×). The optical unit 112d is a soft focus lens with a magnification of 2× (hereinafter, cinema_2×). Thus, the driven unit 112 has optical units of different types with the same magnification. In a case where the driven unit 112 has three optical units, as illustrated in FIG. 3, the three optical units include three of the four lenses described above. The plurality of optical units in the driven unit 112 may include only optical units of different types with the same magnification.

The lens apparatus 1 is switchable between a plurality of modes, and is switchable between a cinema mode (a state in which a soft focus lens is inserted into the optical path) and a normal mode (a state in which a soft focus lens is removed from the optical path) in this example.

The position detector 113 is a detector for detecting the position of the driven unit 112. Since the driven unit 112 in this example is rotatable, the position detector 113 in this example can detect an angle at which the driven unit 112 has rotated from a reference position. A driver 114 is a driver configured to drive the driven unit 112 so that each optical unit provided in the driven unit 112 is inserted into or removed from the optical path. In this example, the position detector 113 and the driver 114 are a known encoder and motor for position detection, respectively. The lens CPU 110 issues a command to the driver 114 based on the setting by the display unit 115 and an optical-unit switching command (information regarding switching of the optical unit) from a lens-controller communication unit 118 or lens-camera communication unit 117. That is, the lens CPU 110 functions as an acquiring unit configured to acquire the designated magnification and mode (information on a plurality of optical characteristics) included in the optical-unit switching command. The lens CPU 110 can also detect which optical unit is inserted into the optical path based on information from the position detector 113.

The display unit (setting unit) 115 includes a display and an operation switch that can notify the user of the state of the lens apparatus 1 and switch the mode of the lens apparatus 1. The mode of the lens apparatus 1 can also be switched by communication from the camera apparatus 2 or a control apparatus 3. In this example, as described above, the mode of the lens apparatus 1 can be switched between the normal mode and the cinema mode. In a case where the mode of the lens apparatus 1 can be set by the display unit 115, the conventional magnification can be switched, but the mode can be switched while using an external device that does not support mode switching.

A memory (storage unit) 116 includes a nonvolatile ROM, for example, and stores information on the optical unit that has been inserted in the optical path, the set magnification and mode, and a relationship between the mode and the corresponding optical unit, as information on an optical characteristic. An optical-unit control unit 122 is provided inside the lens CPU 110, and interprets an instruction from the outside based on the information on the optical characteristic, and issues a command to the driver 114.

The lens-camera communication unit 117 is a communication unit for communicating with the camera apparatus 2. The lens-controller communication unit 118 is a communication unit for communicating with the control apparatus 3.

The camera apparatus 2 converts light from the lens apparatus 1 into an image (video) signal using an imaging unit 201 that includes an image sensor, and adjusts an image (video) by an image (video) signal processing unit 202. The camera CPU 203 is a control unit for the camera apparatus 2, and can communicate with the lens apparatus 1 via the camera communication unit 204.

The control apparatus 3 can communicate with (is connectable to) the lens apparatus 1 via a controller communication unit 303, and operate the optical unit control. A switching unit 302 includes a toggle switch or the like for switching the magnification of the optical unit. The magnification of the optical unit may be switchable by the lens apparatus 1 (for example, the display unit 115). A mode switching unit 304 includes a push switch or the like for switching the mode of the lens apparatus 1. A controller CPU 301 is a control unit of the control apparatus 3, and transmits an instruction for the magnification of the optical unit to the lens apparatus 1 via the controller communication unit 303 according to an operation by a user. In this example, the optical unit is switched so that the driven unit 112 can be controlled from a plurality of operation sources. In this case, a movement in which the last command received takes precedence over the last operation is performed. In this example, the control apparatus 3 is given the role of controlling the driver, but the lens apparatus 1 may control the driver.

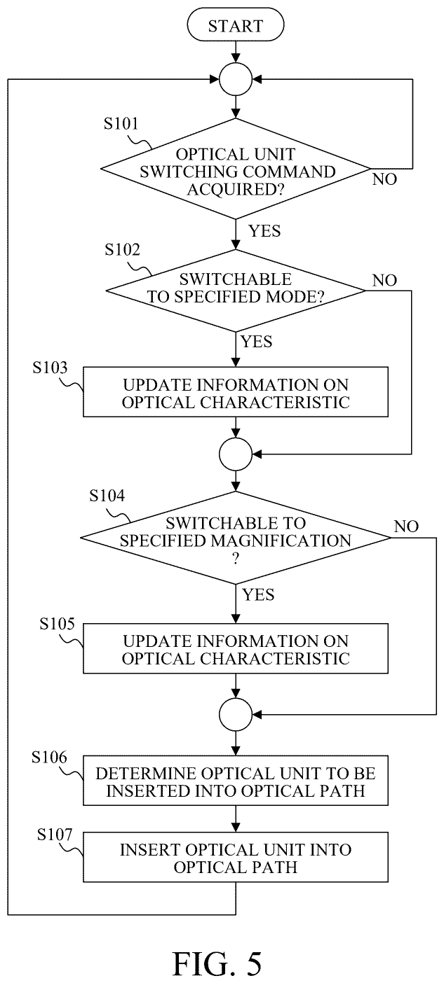

Optical-unit switching processing according to this example will be described below. FIG. 5 is a flowchart illustrating the optical-unit switching processing according to this example. Here, for simplicity, the driven unit 112 includes the four optical units illustrated in FIG. 2, which have the configuration illustrated in FIG. 4.

In step S101, the lens CPU 110 determines whether or not an optical-unit switching command has been acquired from a setting unit such as the display unit 115, the camera apparatus 2, or the control apparatus 3. In a case where the lens CPU 110 determines that an optical-unit switching command has been acquired, the flow proceeds to step S102; otherwise, the flow continues this step.

In step S102, the lens CPU 110 determines whether or not it is possible to switch to the specified mode included in the command acquired in step S101. In a case where the lens CPU 110 determines that it is possible to switch to the specified mode, the flow proceeds to step S103; otherwise, the flow proceeds to step S104. The case in which it is determined that it is not possible to switch to the specified mode includes, for example, a case where the command acquired in step S101 does not include the specified mode or an optical unit corresponding to the specified mode is not provided.

In step S103, the lens CPU 110 updates information on the optical characteristic.

In step S104, the lens CPU 110 determines whether or not it is possible to switch to the specified magnification included in the command acquired in step S101. In a case where the lens CPU 110 determines that the magnification can be changed to the specified magnification, the flow proceeds to step S105; otherwise, the flow proceeds to step S106. The case where it is determined that the magnification cannot be changed to the specified magnification includes, for example, a case where the command acquired in step S101 does not include the specified magnification or an optical unit corresponding to the specified magnification is not provided.

In step S105, the lens CPU 110 updates the information on the optical characteristic.

In step S106, the lens CPU 110 determines the optical unit to be inserted into the optical path based on the information on the optical characteristic. For example, in a case where the optical unit 112a is currently inserted into the optical path and the cinema mode is specified, the lens CPU 110 determines the optical unit 112c to be inserted into the optical path. In a case where the optical unit 112c is currently inserted into the optical path and the magnification is specified as 2×, the lens CPU 110 determines the optical unit 112d to be inserted into the optical path. Thus, the optical unit to be inserted into the optical path is determined based on the mode and the magnification.

In step S107, the optical-unit control unit 122 inserts the optical unit determined in step S106 into the optical path via the driver 114.

For simplicity, in this example, the optical unit corresponding to the normal mode and the optical unit corresponding to the cinema mode have the same magnification, but the disclosure is not limited to this. For example, as illustrated in FIG. 3, the driven unit 112 may include three optical units 112e, 112g, and 112f. Assume that the optical unit 112e has normal_1×, the optical unit 112f has normal_2×, and the optical unit 112g has cinema_1×. At this time, the mode may be specified as the cinema mode and the magnification as 2×. In this case, since there is no optical unit corresponding to this command, even if the mode can be switched (even if the optical unit 112g corresponding to cinema_1× exists), this example does not determine the optical unit to be inserted into the optical path (does not switch the optical unit).

A different communication system (setting unit) may be used to specify both or one of the mode and the magnification. In this example, the mode can be switched in a case where the optical unit corresponding to the normal mode and the optical unit corresponding to the cinema mode have the same magnification. For example, in a case where normal_1× and cinema_1× are provided, the mode can be switched.

As described above, the configuration according to this example can properly switch the optical unit. Since the mode can be switched from the display unit 115, it is possible to use an existing external device that does not support mode switching.

### EXAMPLE 2

This example provides a configuration that always switches a mode if it is switchable. The basic configuration of the camera system is similar to that of Example 1. This example will discuss only the configuration that differs from Example 1, and will omit the common configuration.

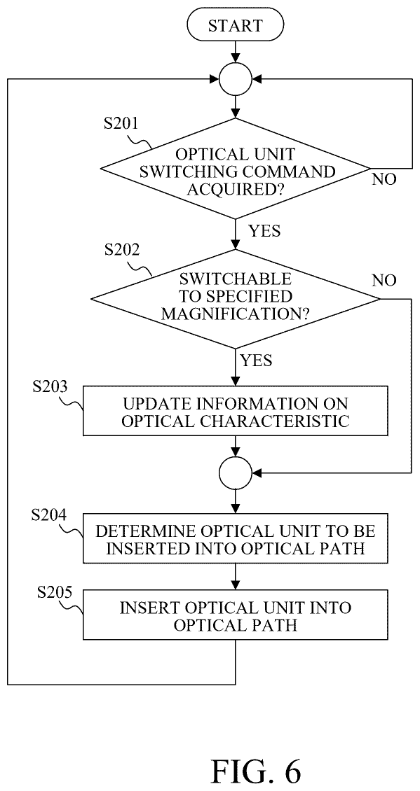

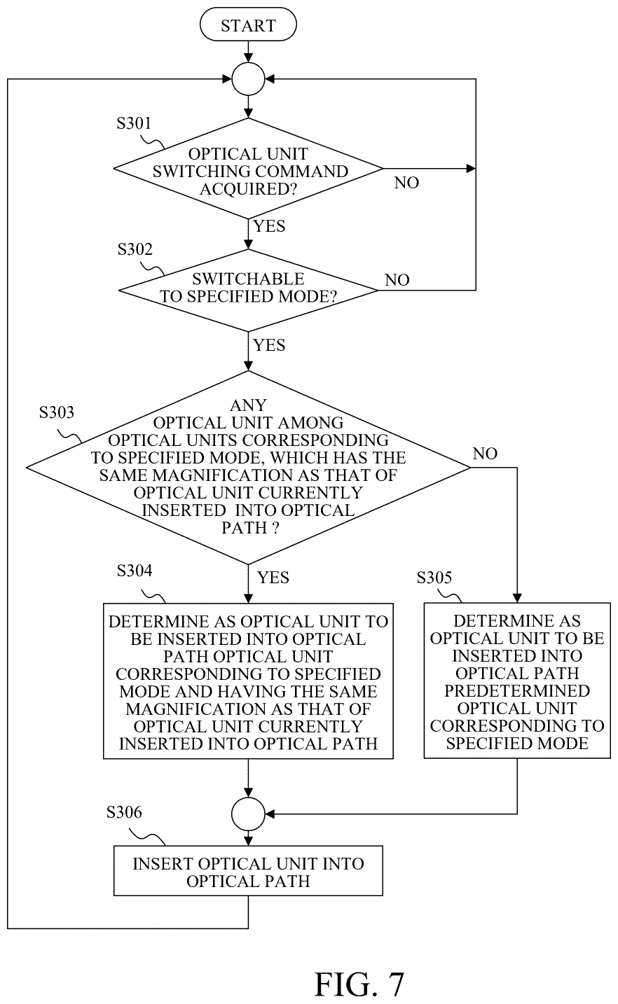

The optical-unit switching processing according to this example will be described below. FIGS. 6 and 7 are flowcharts illustrating the optical-unit switching processing according to this example. For simplicity, the magnification switching will be described with reference to FIG. 6, and the mode switching will be described with reference to FIG. 7.

Referring now to FIG. 6, a description will be given of the magnification switching. In step S201, the lens CPU 110 determines whether or not an optical-unit switching command has been acquired from a setting unit such as the display unit 115, the camera apparatus 2, or the control apparatus 3. In a case where the lens CPU 110 determines that the optical-unit switching command has been acquired, the flow proceeds to step S202; otherwise, the flow continues this step.

In step S202, the lens CPU 110 determines whether or not it is possible to switch to the specified magnification contained in the command acquired in step S201. In a case where the lens CPU 110 determines that it is possible to switch to the specified magnification, the flow proceeds to step S203; otherwise, the flow proceeds to step S204. A case in which it is determined that it is not possible to switch to the specified magnification includes, for example, a case where an optical unit with the specified magnification is not provided.

In step S203, the lens CPU 110 updates information on the optical characteristic.

In step S204, the lens CPU 110 determines the optical unit to be inserted into the optical path based on the information on the optical characteristic.

In step S205, the optical-unit control unit 122 inserts the optical unit determined in step S204 into the optical path via the driver 114.

For example, as illustrated in FIG. 3, assume that the driven unit 112 has three optical units 112e, 112g, and 112f, with optical unit 112e corresponding to normal_1×, optical unit 112f corresponding to normal_2×, and optical unit 112g corresponding to cinema_1×. At this time, in a case where the mode included in the optical-unit switching command is a cinema mode and a magnification is 2×, no optical unit corresponding to this is provided, so this example does not determine the optical unit to be inserted into the optical path (does not switch the optical unit).

Next follows a description of the mode switching with reference to FIG. 7.

In step S301, the lens CPU 110 determines whether or not an optical-unit switching command has been acquired from a setting unit such as the display unit 115, the camera apparatus 2, or the control apparatus 3. In a case where the lens CPU 110 determines that an optical-unit switching command has been acquired, the flow proceeds to step S302; otherwise, the flow continues this step.

In step S302, the lens CPU 110 determines whether or not it is possible to switch to the specified mode included in the command acquired in step S301. In a case where the lens CPU 110 determines that it is possible to switch to the specified mode, the flow proceeds to step S303; otherwise, the flow proceeds to step S301. A case in which it is determined that it is not possible to switch to the specified mode includes, for example, a case where an optical unit corresponding to the specified mode is not provided.

In step S303, the lens CPU 110 determines whether or not there is an optical unit of the optical units corresponding to the specified mode, which has the same magnification as that of the optical unit currently inserted into the optical path. In a case where the lens CPU 110 determines that the optical unit with the same magnification exists, the flow proceeds to step S304; otherwise, the flow proceeds to step S305.

In step S304, the lens CPU 110 determines an optical unit that corresponds to the specified mode and has the same magnification as that of the optical unit currently inserted into the optical path as the optical unit to be inserted into the optical path. For example, assume that the driven unit 112 has normal_1×, normal_2×, and cinema_1×. In this case, in a case where the normal mode is specified and the optical unit 112g is currently inserted into the optical path, the optical unit 112e is determined as the optical unit to be inserted into the optical path.

In step S305, the lens CPU 110 determines a predetermined optical unit from among the optical units that corresponds to the specified mode as the optical unit to be inserted into the optical path. The specific optical unit may include, for example, the optical unit with the lowest magnification. Alternatively, the specific optical unit may not be previously determined, but may be set by the user, for example, from the display unit 115.

In step S306, the optical-unit control unit 122 inserts the optical unit determined in step S304 or S305 into the optical path via the driver 114.

Whether or not to perform the optical-unit switching processing according to this example may be set by the display unit 115.

### EXAMPLE 3

In Examples 1 and 2, in a case where there is no optical unit with the specified magnification among the optical units corresponding to the specified mode or the current mode, the optical unit to be inserted into the optical path is not determined. In such a case, this example determines the optical unit with the specified magnification as the optical unit to be inserted into the optical path regardless of the mode. The basic configuration of the camera system is similar to that of Example 1. This example will discuss only the configuration different from Examples 1 and 2, and will omit the common configuration.

The switching unit 302 generally includes a toggle switch (1×/2×). For example, assume that the driven unit 112 has normal_1×, normal_2×, and cinema_1×. In a case where the optical unit currently inserted into the optical path is cinema 1×, in Example 2, the toggle switch 2× of the control apparatus 3 is not effective. There are cases where the user may be able to perform some operation even if the toggle switch 2× is operated.

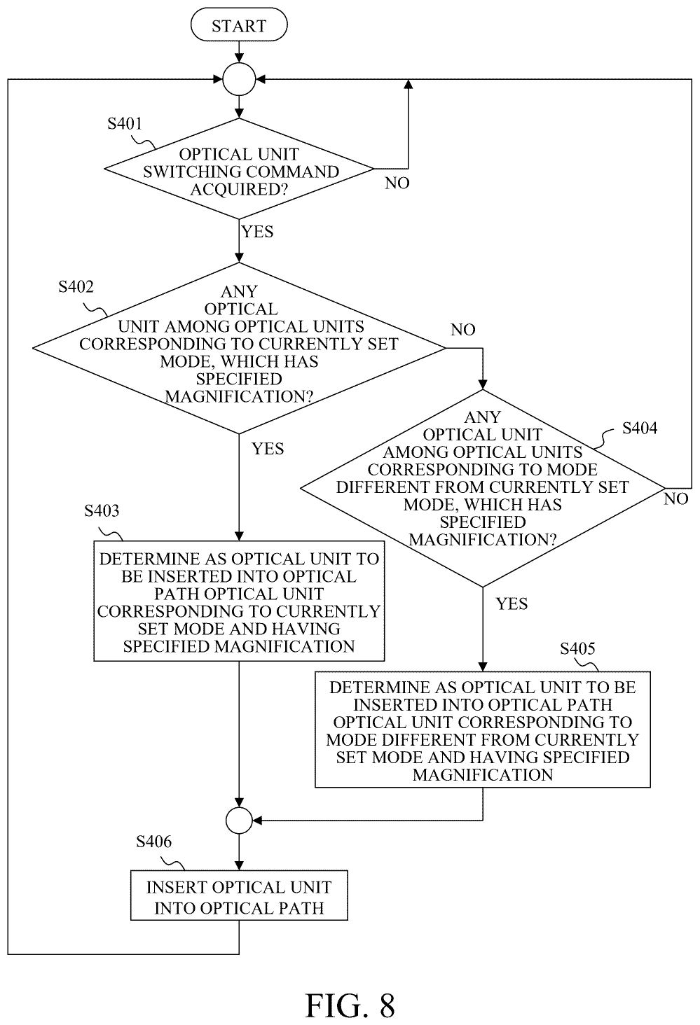

The optical-unit switching processing according to this example will be described below. The processing when a mode is switched is similar to the flow in FIG. 7, so a description thereof will be omitted. The processing when the magnification is switched will be described below. FIG. 8 is a flowchart illustrating the optical-unit switching processing according to this example.

In step S401, the lens CPU 110 determines whether or not an optical-unit switching command has been acquired from the display unit 115, the camera apparatus 2, the control apparatus 3, or the like. In a case where the lens CPU 110 determines that an optical-unit switching command has been acquired, the flow proceeds to step S402; otherwise, the flow continues this step.

In step S402, the lens CPU 110 determines whether or not an optical unit with the specified magnification included in the command acquired in step 401 exists among the optical units corresponding to the currently set mode. In a case where the lens CPU 110 determines that an optical unit with the specified magnification exists, the flow proceeds to step S403; otherwise, the flow proceeds to step S404.

In step S403, the lens CPU 110 determines an optical unit that corresponds to the currently set mode and has the specified magnification as the optical unit to be inserted into the optical path.

In step S404, the lens CPU 110 determines whether or not an optical unit with the specified magnification exists among the optical units that correspond to a mode different from the currently set mode. In a case where the lens CPU 110 determines that such an optical unit exists, the flow proceeds to step S405; otherwise, the flow proceeds to step S401.

In step S405, the lens CPU 110 determines an optical unit that corresponds to a mode different from the currently set mode and has the specified magnification as the optical unit to be inserted into the optical path.

In step S406, the optical-unit control unit 122 inserts the optical unit determined in step S403 or S405 into the optical path via the driver 114.

Due to the above processing, in a case where an optical unit that corresponds to the specified mode but has the specified magnification does not exist, it is possible to switch to an optical unit that corresponds to a different mode but has the specified magnification.

This example switches the mode via communication or the display unit 115, but in a case where an optical unit corresponding to the cinema mode exists, this may be stored in the memory 116, and the cinema mode may be compulsorily set.

Whether or not to perform the optical-unit switching processing according to this example may be set by the display unit 115.

### EXAMPLE 4

This example drives with priority the optical unit corresponding to the normal mode among the optical units with the specified magnification. In a case where a magnification that does not exist in the magnification of the optical unit corresponding to the normal mode is specified, the optical unit is switched to the optical unit corresponding to the cinema mode. The basic configuration of the camera system is similar to that of Example 1. This example will discuss only the configuration that differs from Examples 1 to 3, and will omit the common configuration.

This example switches to the optical unit corresponding to the cinema mode in a case where a magnification that does not exist in the magnification of the optical unit corresponding to the normal mode is specified. More specifically, in a case where the magnification of the optical unit corresponding to the normal mode is 1× or 2×, and the specified magnification is 0.8× or 1.5×, the optical unit is switched to the optical unit corresponding to the cinema mode. For simplicity, assume that the driven unit 112 has normal_1×, normal_2×, and cinema_1×. In a case where a magnification that does not exist in the magnifications of the optical units corresponding to the normal mode is specified, it is switched to cinema_1×. The display unit 115 may change what determines the switching to the optical unit corresponding to the cinema mode.

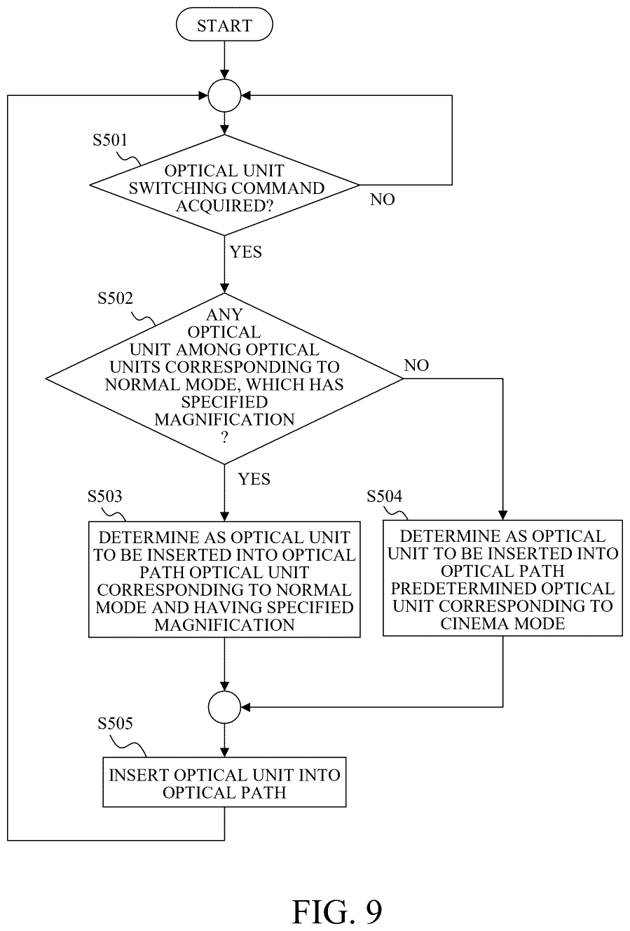

FIG. 9 is a flowchart illustrating the optical-unit switching processing according to this example.

In step S501, the lens CPU 110 determines whether or not it has acquired an optical-unit switching command from the display unit 115, the camera apparatus 2, the control apparatus 3, or the like. In a case where the lens CPU 110 determines that it has acquired an optical-unit switching command, the flow proceeds to step S502; otherwise, the flow continues this step.

In step S502, the lens CPU 110 determines whether or not there is an optical unit with the specified magnification included in the command acquired in step S401 among the optical units corresponding to the normal mode. In a case where the lens CPU 110 determines that an optical unit with the specified magnification exists, the flow proceeds to step S503; otherwise, the flow proceeds to step S504.

In step S503, the lens CPU 110 determines an optical unit that corresponds to the normal mode and has the specified magnification as the optical unit to be inserted into the optical path.

In step S504, the lens CPU 110 determines a predetermined optical unit from among the optical units that correspond to the cinema mode as the optical unit to be inserted into the optical path.

In step S505, the optical-unit control unit 122 inserts the optical unit determined in step S503 or S504 into the optical path via the driver 114.

The mode switching may be used to determine whether or not to enable a communication interpretation change for switching to an optical unit that corresponds to the cinema mode. The default magnification interpretation may be reversed between the normal mode and the cinema mode. In a case where there are a plurality of optical units corresponding to the cinema mode, an optical unit with the specified magnification may be determined, or an optical unit with a smaller magnification may be determined.

### EXAMPLE 5

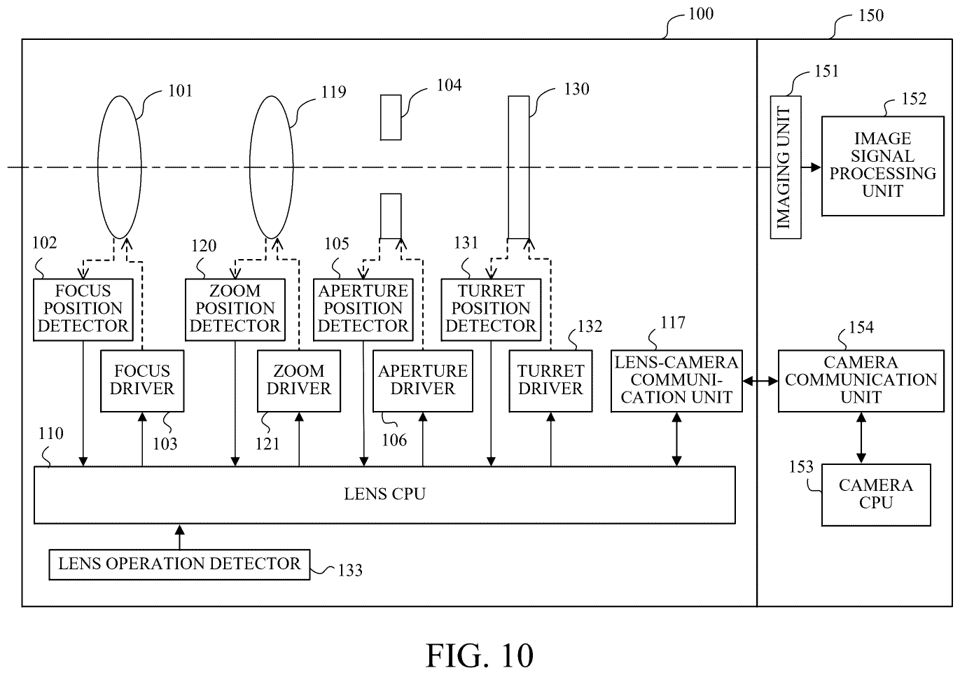

Referring now to FIG. 10, a description will be given of the configuration of a camera system including an optical-area switching apparatus (lens apparatus) according to this example.

FIG. 10 is a configuration diagram of a camera system that includes the lens apparatus 100 including the turret 130 as the optical-area switching apparatus, and a camera apparatus 150.

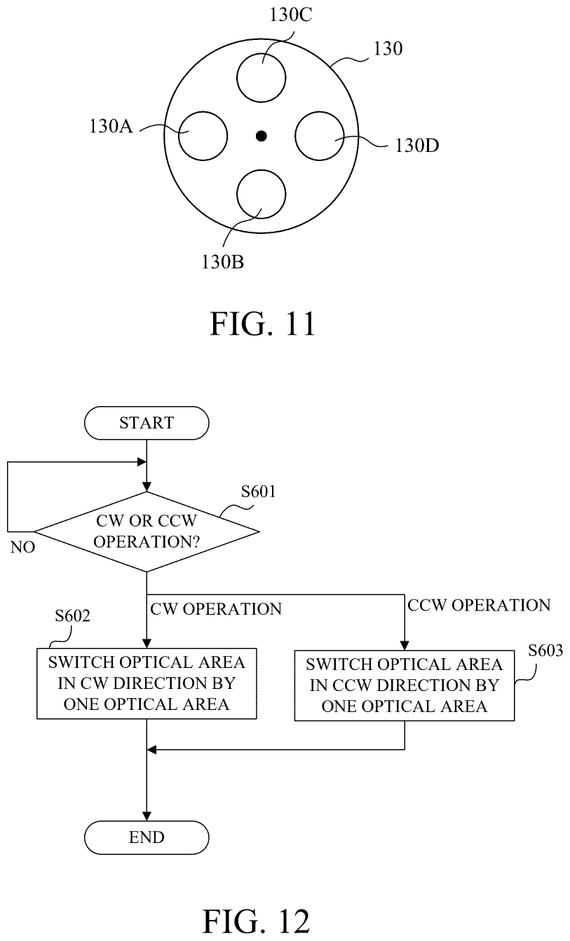

As illustrated in FIG. 11, the turret 130 has a first optical area 130A, a second optical area 130B, a third optical area 130C, and a fourth optical area 130D arranged on a circumference. The first optical area 130A has an imaging magnification of 1× in the entire optical system, and includes an optical element that intentionally produces spherical aberration. The second optical area 130B has an imaging magnification of 2× in the entire optical system, and includes an optical element that intentionally produces spherical aberration. The third optical area 130C includes an optical element that has an imaging magnification of 1× in the entire optical system and has less spherical aberration than that of each of the first optical area 130A and the second optical area 130B. The third optical area 130C may be a blank area that has no optical element. The fourth optical area 130D includes an optical element that has an imaging magnification of 2× in the entire optical system and has less spherical aberration than that of each of the first optical area 130A and the second optical area 130B. In other words, the turret 130 can be divided into at least two optical area groups by optical characteristic other than the imaging magnification (in this case, spherical aberration characteristic), and each of the two optical area groups has at least two optical areas (optical units) with different imaging magnifications within the same optical area group.

By using such an optical-area switching apparatus (turret 130), it is not necessary to align the filter switching turret and the magnification switching extender in the optical axis direction, so that an optical-area switching apparatus can have a reduced size in the optical axis direction.

In FIG. 11, the first optical area 130A is disposed in the direction of 9 o'clock, the second optical area 130B is disposed in the direction of 6 o'clock, the third optical area 130C is disposed in the direction of 12 o'clock, and the fourth optical area 130D is disposed in the direction of 3 o'clock, but the disclosure is not limited to this example. For example, the first optical area 130A may be disposed in the 9 o'clock direction, the second optical area 130B may be disposed in the 3 o'clock direction, the third optical area 130C may be disposed in the 12 o'clock direction, and the fourth optical area 130D may be disposed in the 6 o'clock direction.

The imaging magnifications of the entire optical system of the first optical area 130A to the fourth optical area 130D are set to 1×, 2×, 1×, and 2×, respectively, but may be other magnifications. For example, they may be 1.5×, 2.5×, 1×, 1.5×, etc., respectively.

The first optical area 130A and the second optical area 130B include optical elements that intentionally produce spherical aberration, but may be optical elements having other optical characteristics. For example, they may be ND filters for adjusting a light amount passing through the lens apparatus 100, visible light cut filters for cutting visible light, color correction filters for correcting color, etc.

The optical element referred to here is not limited to a single optical element, but may be a combination of multiple optical elements. For example, they may be a combination of a filter for intentionally producing spherical aberration and a lens for changing the imaging magnification in the entire optical system.

The turret driver 132 is a driver mechanically connected to the turret 130, and includes a known driver circuit and a motor in this example.

The turret position detector 131 is a position detector mechanically, magnetically, or optically connected to the turret 130, and includes a known encoder for position detection in this example.

The lens CPU 110 can control the drive of the focus lens 101 to a target position by acquiring current position information on the focus lens 101 from the focus position detector 102 and issuing a control command to the focus driver 103.

Similarly, the lens CPU 110 acquires current position information on the zoom lens 119, the aperture unit 104, and the turret 130 from the zoom position detector 120, the aperture position detector 105, and the turret position detector 131, respectively. Then, the lens CPU 110 can control the drive of the zoom lens 119 to a target position by issuing a control command to the zoom lens driver 121, the aperture driver 106, and the turret driver 132, respectively.

The lens operation detector (switching operation detector) 133 is a detector that can detect operations by the user. More specifically, it includes a plurality of switches (not illustrated) and can detect switching operations by the user. The lens operation detector 133 transmits an operation detection result to the lens CPU 110, and the lens CPU 110 performs a variety of controls based on the received information. The user can switch at least the first optical area 130A to the fourth optical area 130D (perform optical area switching operation) by operating the lens operation detector 133. Here, the lens operation detector 133 is a type that simply detects a switch operation by the user, but it may also be a type that detects operations by a combination of a menu displayed on a display (not illustrated) and a switch operation or a touch panel operation by the user.

In this example, the lens operation detector 133 is built in the lens apparatus 100, but may be built in an external device (not illustrated), and the lens apparatus 100 may further include a communication unit with the external device to acquire a lens operation detection result by the communication unit with the external device.

The lens-camera communication unit 117 is a communication unit that can communicate with the camera apparatus 150. The lens CPU 110 can communicate information with the camera apparatus 150 via the lens-camera communication unit 117.

The camera apparatus 150 receives light output from the lens apparatus 100 by an imaging unit 151.

The imaging unit 151 converts the received light into an image (video) signal and outputs it to an image signal processing unit 152.

The image signal processing unit 152 processes a variety of image signals.

A camera CPU 153 performs a variety of controls for the camera apparatus 150.

A camera communication unit 154 is a communication unit that can communicate with the lens-camera communication unit 117. The camera CPU 153 can exchange information with the lens CPU 110 via the camera communication unit 154.

In this example, the camera system includes the lens apparatus 100 and the camera apparatus 150, but this example is not limited to this implementation and the disclosure can also be applied to an image pickup apparatus in which the lens apparatus 100 and the camera apparatus 150 are integrated.

The configuration diagram of the camera system including the optical-area switching apparatus according to this example has been discussed.

A flowchart of clockwise (CW) and counterclockwise (CCW) switching optical areas in this example will be described below with reference to FIG. 12.

In step (S in the figure) 601, the turret position detector 131 detects a user operation. In a case where no user operation is detected, the flow returns to step 601. In a case where a clockwise (CW) operation is detected, the flow proceeds to step 602, and in a case where a counterclockwise (CCW) operation is detected, the flow proceeds to step 603.

In step 602, the lens CPU 110 issues a CW control command to the turret driver 132. Upon receiving the CW control command, the turret driver 132 drives the turret 130 clockwise. During this time, the lens CPU 110 detects the position of the turret 130 using the turret position detector 131, and in a case where it detects that the turret 130 has reached the desired position, it stops issuing the control command to the turret driver 132 and the flow ends. For example, in a case where the optical area currently positioned on the optical axis is the third optical area 130C, the CW control command switches to the first optical area 130A.

In step 603, the lens CPU 110 issues a CCW control command to the turret driver 132. The turret driver 132, which has received the CCW control command, drives the turret 130 counterclockwise. During this time, the lens CPU 110 detects the position of the turret 130 using the turret position detector 131, and in a case where it detects that the turret 130 has reached the desired position, it stops issuing the control command to the turret driver 132 and the flow ends. For example, in a case where the optical area currently positioned on the optical axis is the third optical area 130C, it is switched to the fourth optical area 130D by a CCW control command.

Thus, the optical-area CW/CCW switching flowchart according to this example has been discussed.

### EXAMPLE 6

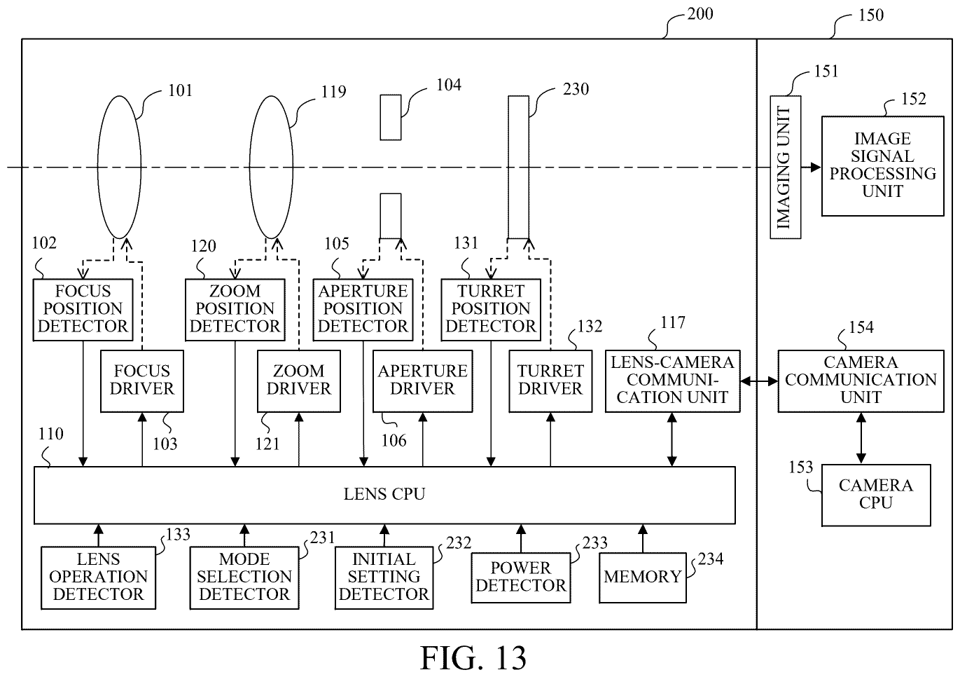

Referring now to FIG. 13, a description will be given of the configuration diagram of a camera system including an optical-area switching apparatus according to this example. FIG. 13 is a configuration diagram of a camera system consisting of a lens apparatus 200 including a turret 230 as an optical-area switching apparatus, and a camera apparatus 150. Those elements, which are corresponding elements in Example 5, will be designated by the same reference numerals, and a description thereof will be omitted.

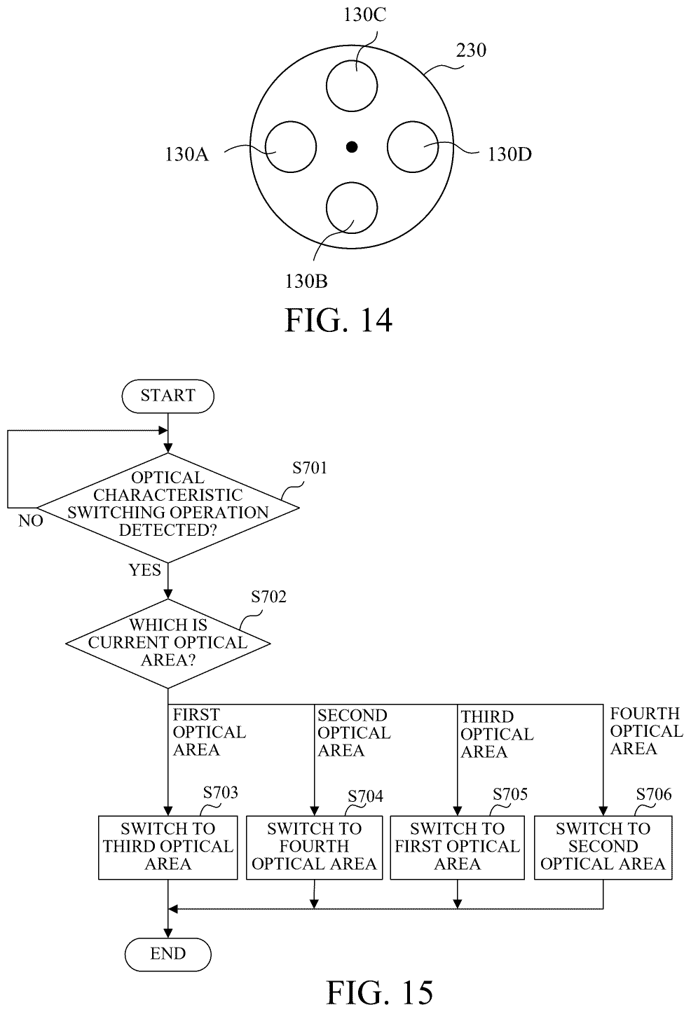

As illustrated in FIG. 14, the turret 230 has a first optical area 130A, a second optical area 130B, a third optical area 130C, and a fourth optical area 130D arranged on a circumference. In FIG. 14, the first optical area 130A is disposed in the direction of 9 o'clock, the second optical area 130B is disposed in the direction of 6 o'clock, the third optical area 130C is disposed in the direction of 12 o'clock, and the fourth optical area 130D is disposed in the direction of 3 o'clock.

By using such an optical-area switching apparatus (turret 230), it is not necessary to align the filter switching turret and the magnification switching extender in the optical axis direction, so that an optical-area switching apparatus can have a reduced size in the optical axis direction.

The turret driver 132 is a driver mechanically connected to the turret 230, and includes a known driver circuit and a motor in this example.

The turret position detector 131 is a position detector mechanically, magnetically, or optically connected to the turret 230, and includes a known encoder for position detection in this example.

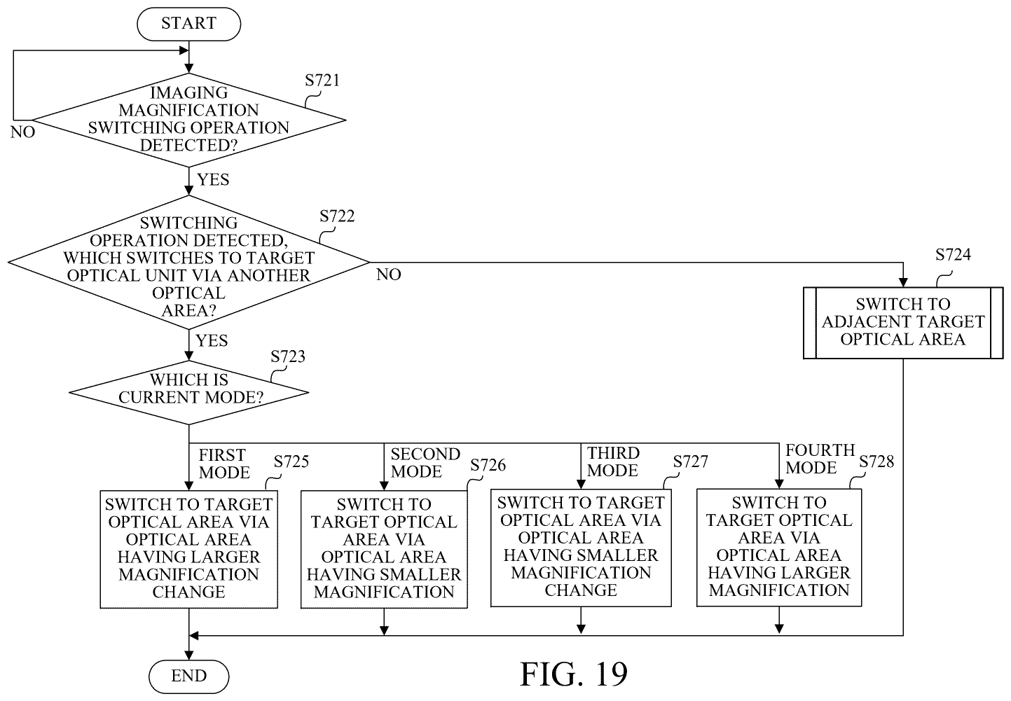

A mode selection detector 231 can detect a mode selection by a user. More specifically, it includes a plurality of switches (not illustrated) and can detect switch operations by the user. The mode selection detector 231 transmits a mode selection detection result to the lens CPU 110, and the lens CPU 110 performs a variety of controls based on the received information. Details will be discussed in the flowchart illustrated in FIG. 19 described later.

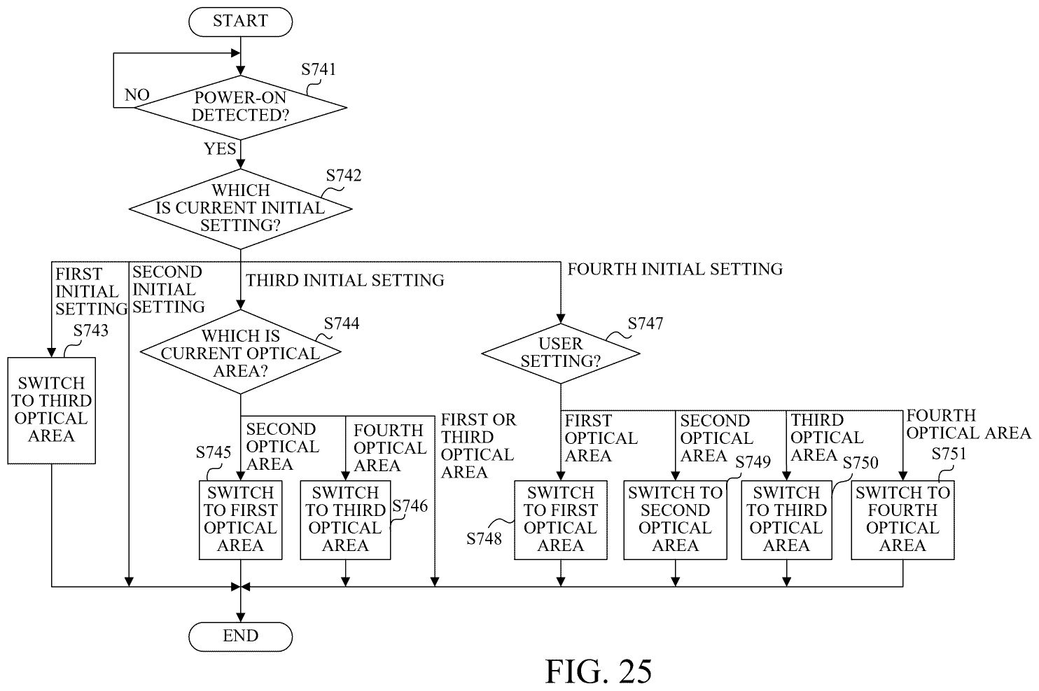

An initial setting detector 232 can detect initial settings by a user. More specifically, it includes a plurality of switches (not illustrated) and can detect switch operations by the user. The initial setting detector 232 transmits a mode selection operation detection result to the lens CPU 110, and the lens CPU 110 performs a variety of controls based on the received information. Details will be discussed later in the flowchart of FIG. 25.

The lens operation detector 133, the mode selection detector 231, and the initial setting detector 232 are configured independently of each other, but the disclosure is not limited to this example. A detecting method may use a combination of a menu displayed on a display (not illustrated) and a switch operation or a touch panel operation by the user.

A power detector 233 can detect the power on/off operation (power state) of the lens apparatus 200 by the user. The power detector 233 transmits a power detection result to the lens CPU 110, and the lens CPU 110 performs a variety of controls based on the received information. It is not limited to the detection of the power on/off operation of the lens apparatus 200 by the user, and may also monitor the power supply voltage and detect the power on/off of the lens apparatus 200.

A memory 234 can store various information on the lens apparatus 200. The lens CPU 110 can store and read various information from the memory 234. For example, the result (mode) detected by the mode selection detector 231 and the result (initial setting) detected by the initial setting detector 232 can be stored.

In this example, the camera system includes the lens apparatus 200 and the camera apparatus 150, but the disclosure is not limited to this example and can also be applied to an image pickup apparatus in which the lens apparatus 200 and the camera apparatus 150 are integrated.

Thus, the configuration diagram of the camera system includes the optical-area switching apparatus according to this example.

This example also uses the optical-area CW/CCW switching flowchart illustrated in FIG. 12 according to Example 5. Since the flowchart is the same, a description thereof will be omitted.

The optical-characteristic switching flowchart according to this example will be described below with reference to FIG. 15.

In step 701, the lens operation detector 133 detects the optical characteristic switching operation by the user. The optical characteristic switching referred to herein will be discussed with specific examples in steps 703 to 706. In a case where no user operation is detected, the flow returns to step 701; in a case where a user operation is detected, the flow proceeds to step 702.

In step 702, the lens CPU 110 determines which of the first optical area 130A to fourth optical area 130D is currently positioned on the optical axis. At this time, the lens CPU 110 may determine the optical area currently positioned on the optical axis from the turret position detector 131, or may store the optical area currently positioned on the optical axis in advance in the memory 234 and read that information from the memory to make the determination. In a case where the optical area currently positioned on the optical axis is the first optical area 130A, the flow proceeds to step 703, in a case where it is the second optical area 130B, the flow proceeds to step 704, in a case where it is the third optical area 130C, the flow proceeds to step 705, and in a case where it is the fourth optical area 130D, the flow proceeds to step 706.

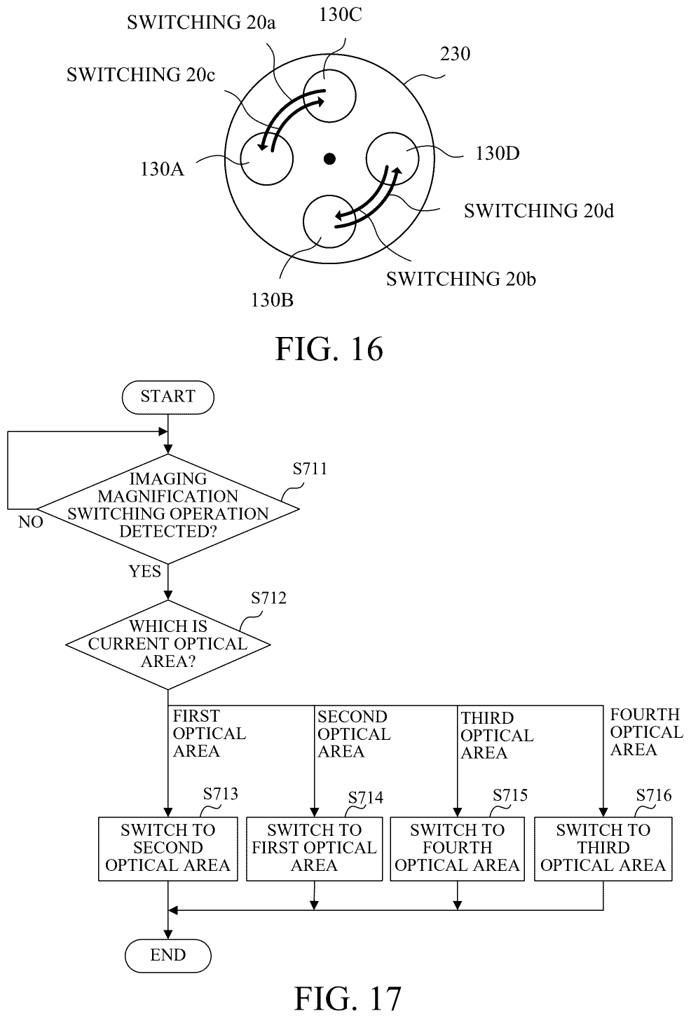

In step 703, the lens CPU 110 issues a control command to the turret driver 132 to switch the optical area currently positioned on the optical axis from the first optical area 130A to the third optical area 130C. The turret driver 132 that has received the control command drives the turret 230. During that time, the lens CPU 110 detects the position of the turret 230 using the turret position detector 131, and in a case where it detects that the turret 230 has reached the desired position, it stops issuing the control command to the turret driver 132 and this flow ends. The switching operation at this time is schematically illustrated as switching 20a in FIG. 16. In other words, in step 703, the imaging magnification remains unchanged at 1×, and the optical element that intentionally produces spherical aberration is switched to an optical element that suppresses spherical aberration.

In step 704, the lens CPU 110 issues a control command to the turret driver 132 to switch the optical area currently positioned on the optical axis from the second optical area 130B to the fourth optical area 130D. The turret driver 132 that has received the control command drives the turret 230. During this time, the lens CPU 110 detects the position of the turret 230 using the turret position detector 131, and in a case where it detects that the turret 230 has reached the desired position, it stops issuing the control command to the turret driver 132 and this flow ends. The switching operation at this time is schematically illustrated as switching 20b in FIG. 16. In other words, in step 704, the imaging magnification remains unchanged at 2×, and the optical element that intentionally produces spherical aberration is switched to an optical element that suppresses spherical aberration.

In step 705, the lens CPU 110 issues a control command to the turret driver 132 to switch the optical area currently positioned on the optical axis from the third optical area 130C to the first optical area 130A. The turret driver 132 that has received the control command drives the turret 230. During this time, the lens CPU 110 detects the position of the turret 230 using the turret position detector 131, and in a case where it detects that the turret 230 has reached the desired position, it stops issuing the control command to the turret driver 132 and the flow ends. The switching operation at this time is schematically illustrated as switching 20c in FIG. 16. In other words, in step 705, the imaging magnification remains unchanged at 1×, and the optical element that suppresses spherical aberration is switched to an optical element that intentionally generates spherical aberration.

In step 706, the lens CPU 110 issues a control command to the turret driver 132 to switch the optical area currently positioned on the optical axis from the fourth optical area 130D to the second optical area 130B. The turret driver 132 that has received the control command drives the turret 230. During this time, the lens CPU 110 detects the position of the turret 230 using the turret position detector 131, and in a case where it detects that the turret 230 has reached the desired position, it stops issuing the control command to the turret driver 132 and the flow ends. The switching operation at this time is schematically illustrated as switching 20d in FIG. 16. In other words, in step 706, the imaging magnification remains unchanged at 2×, and the optical element that suppresses spherical aberration is switched to an optical element that intentionally produces spherical aberration.

As described for the turret 230, the first optical area 130A and the second optical area 130B, which have optical characteristics that intentionally produce spherical aberration, are arranged adjacent to each other on the turret 230. The first optical area 130A and the third optical area 130C, which have the imaging magnification of 1×, are arranged adjacent to each other. As a result, in switching the spherical aberration characteristics while the imaging magnification is maintained, the optical area can be switched without passing through an unnecessary optical area, as illustrated by switching 20a to switching 20d in FIG. 16.

Thus, the optical-characteristic switching flowchart according to this example has been discussed.

The imaging-magnification switching flowchart according to this example will be described below with reference to FIG. 17.

In step 711, the lens operation detector 133 detects an imaging-magnification switching operation by the user. The imaging magnification switching will be described with specific examples in steps 713 to 716. In a case where a user operation is not detected, the flow returns to step 711, and in a case where a user operation is detected, the flow proceeds to step 712.

In step 712, the lens CPU 110 determines which of the first optical area 130A to fourth optical area 130D is currently positioned on the optical axis. At this time, the lens CPU 110 may determine the optical area currently positioned on the optical axis using the turret position detector 131, or may store the optical area currently positioned on the optical axis in advance in the memory 234 and read that information from the memory 234 to make the determination. In a case where the optical area currently positioned on the optical axis is the first optical area 130A, the flow proceeds to step 713, in a case where it is the second optical area 130B, the flow proceeds to step 714, in a case where it is the third optical area 130C, the flow proceeds to step 715, and in a case where it is the fourth optical area 130D, the flow proceeds to step 716.

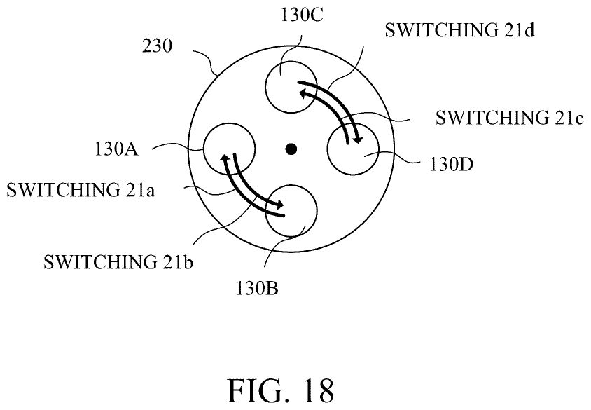

In step 713, the lens CPU 110 issues a control command to the turret driver 132 to switch the optical area currently positioned on the optical axis from the first optical area 130A to the second optical area 130B. The turret driver 132 that receives the control command drives the turret 230. During this time, the lens CPU 110 detects the position of the turret 230 using the turret position detector 131, and in a case where it detects that the turret 230 has reached the desired position, it stops issuing the control command to the turret driver 132 and the flow ends. The switching operation at this time is schematically illustrated as switching 21a in FIG. 18. In other words, in step 713, the optical element that intentionally produces spherical aberration remains unchanged, and the imaging magnification has been switched from 1× to 2×.

In step 714, the lens CPU 110 issues a control command to the turret driver 132 to switch the optical area currently positioned on the optical axis from the second optical area 130B to the first optical area 130A. The turret driver 132 that has received the control command drives the turret 230. During this time, the lens CPU 110 detects the position of the turret 230 using the turret position detector 131, and in a case where it detects that the turret 230 has reached the desired position, it stops issuing the control command to the turret driver 132 and the flow ends. The switching operation at this time is schematically illustrated as switching 21b in FIG. 18. In other words, in step 714, the optical element that intentionally produces spherical aberration remains unchanged, and the imaging magnification is switched from 2× to 1×.

In step 715, the lens CPU 110 issues a control command to the turret driver 132 to switch the optical area currently positioned on the optical axis from the third optical area 130C to the fourth optical area 130D. The turret driver 132 that has received the control command drives the turret 230. During this time, the lens CPU 110 detects the position of the turret 230 using the turret position detector 131, and in a case where it detects that the turret 230 has reached the desired position, it stops issuing the control command to the turret driver 132 and the flow ends. The switching operation at this time is schematically illustrated as switching 21c in FIG. 18. In step 715, the optical element suppressing spherical aberration remains unchanged, and the imaging magnification is switched from 1× to 2×.

In step 716, the lens CPU 110 issues a control command to the turret driver 132 to switch the optical area currently positioned on the optical axis from the fourth optical area 130D to the third optical area 130C. The turret driver 132 that has received the control command drives the turret 230. During this time, the lens CPU 110 detects the position of the turret 230 using the turret position detector 131, and in a case where it detects that the turret 230 has reached the desired position, it stops issuing the control command to the turret driver 132 and the flow ends. The switching operation at this time is schematically illustrated as switching 21d in FIG. 18. In other words, in step 716, the imaging magnification is switched from 2× to 1× while the optical element suppressing spherical aberration remains unchanged.

As described for the turret 230, the first optical area 130A and the second optical area 130B, which have optical characteristics that intentionally produce spherical aberration, are arranged adjacent to each other on the turret 230. The first optical area 130A and the third optical area 130C, which have the imaging magnification of 1×, are arranged adjacent to each other. Thereby, the optical area can be switched without passing through any unnecessary optical areas, as illustrated by switching 21a to switching 21d in FIG. 18, in switching the imaging magnification while the spherical aberration characteristic is maintained.

Thus, the imaging-magnification switching flowchart according to this example has been discussed.

Referring now to FIG. 19, a description will be given of a switching flowchart in switching to the desired optical area via another optical area in the second embodiment.

In step 721, the lens operation detector 133 detects the user's operation to switch the optical area. In a case where no user operation is detected, the flow returns to step 721; in a case where a user operation is detected, the flow proceeds to step 722.

In step 722, the lens CPU 110 determines whether the detected user operation is “switching to the desired optical area via another optical area.” For example, in a case where the optical area currently positioned on the optical axis is the first optical area 130A, it is necessary to pass through the second optical area 130B or the third optical area 130C in order to switch to the fourth optical area 130D. This is the case of “switching to the desired optical area via another optical area.” In the case of switching to the desired optical area via the other optical area, the flow proceeds to step 723; otherwise, the flow proceeds to step 724.

In step 723, the mode selection detector 231 detects the currently selected mode. The mode includes a first mode to a fourth mode. Each mode will be discussed with a concrete example in steps 725 to 728. In a case where the detected mode is the first mode, the flow proceeds to step 725; in a case where the detected mode is the second mode, the flow proceeds to step 726; in a case where the detected mode is the third mode, the flow proceeds to step 727; in a case where the detected mode is the fourth mode, the flow proceeds to step 728.

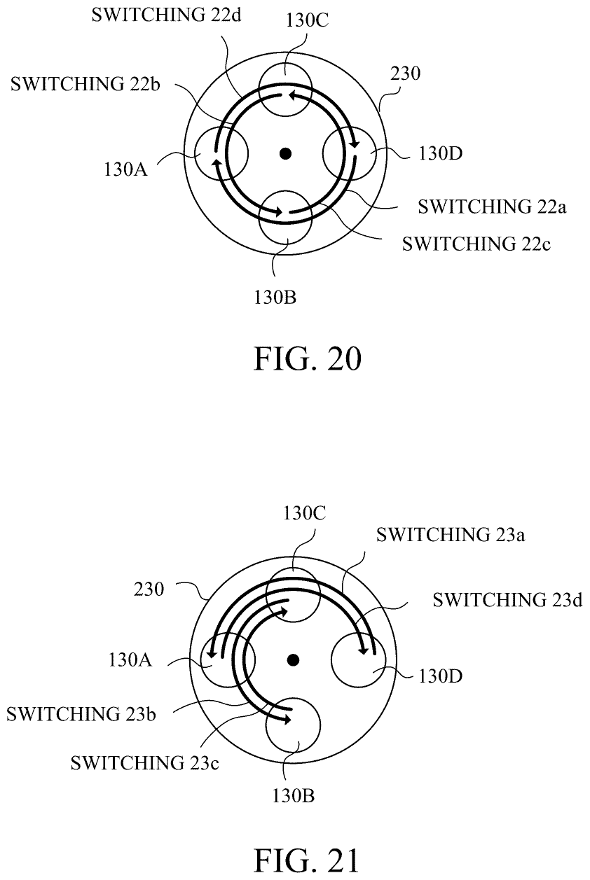

In step 725, the lens CPU 110 issues a control command to the turret driver 132 to switch to the desired optical area via the optical area with a larger magnification change. The turret driver 132 that has received the control command drives the turret 230. During this time, the lens CPU 110 detects the position of the turret 230 using the turret position detector 131, and in a case where it detects that the turret 230 has reached the desired position, it stops issuing the control command to the turret driver 132 and the flow ends. The switching operation at this time is schematically illustrated as in switching 22a to switching 22d in FIG. 20. For example, in switching from the first optical area 130A to the fourth optical area 130D, the imaging magnification of the first optical area 130A is 1×, the imaging magnification of the second optical area 130B is 2×, and the imaging magnification of the third optical area 130C is 1×. Therefore, switching is performed to the fourth optical area 130D via the second optical area 130B, which has a large change in imaging magnification (switching 22a). Similarly, in switching from the second optical area 130B to the third optical area 130C, switching is performed to the switching 22b. Also, in switching from the third optical area 130C to the second optical area 130B, switching is performed to the switching 22c, and in a case where switching from the fourth optical area 130D to the first optical area 130A, switching is performed to the switching 22d.

In the first mode, the imaging magnification, which has a large change in a captured image, is changed first, and then the spherical aberration characteristic, which has a relatively small change in the captured image, is changed, so that the user can easily recognize the change in the spherical aberration characteristic. As described for the turret 230, by arranging the first optical area 130A to the fourth optical area 130D on the turret 230, the switching in the first mode can be performed efficiently, as illustrated by switching 22a to switching 22d in FIG. 20.

In step 726, the lens CPU 110 issues a control command to the turret driver 132 to switch to the target optical area via an optical area with a smaller magnification. The turret driver 132 that has received the control command drives the turret 230. During this time, the lens CPU 110 detects the position of the turret 230 using the turret position detector 131, and in a case where it detects that the turret 230 has reached the desired position, it stops issuing the control command to the turret driver 132 and the flow ends. The switching operation at this time is schematically illustrated as illustrated by switching 23a to switching 23d in FIG. 21. For example, in switching from the first optical area 130A to the fourth optical area 130D, the imaging magnification of the second optical area 130B is 2×, and the imaging magnification of the third optical area 130C is 1×. Therefore, switching is made to the fourth optical area 130D via the third optical area 130C, which has a smaller imaging magnification (switching 23a). Similarly, in switching from the second optical area 130B to the third optical area 130C, switching is made to switching 23b. In switching from the third optical area 130C to the second optical area 130B, switching is made to switching 23c, and in switching from the fourth optical area 130D to the first optical area 130A, switching is made to switching 23d.

In the second mode, by switching to the desired optical area via an optical area with a smaller imaging magnification, i.e., a wide-angle optical area, the user is less likely to lose sight of an object. As described for the turret 230, by arranging the first optical area 130A to the fourth optical area 130D on the turret 230, switching in the second mode can be performed efficiently, as illustrated by switching 23a to switching 23d in FIG. 21.

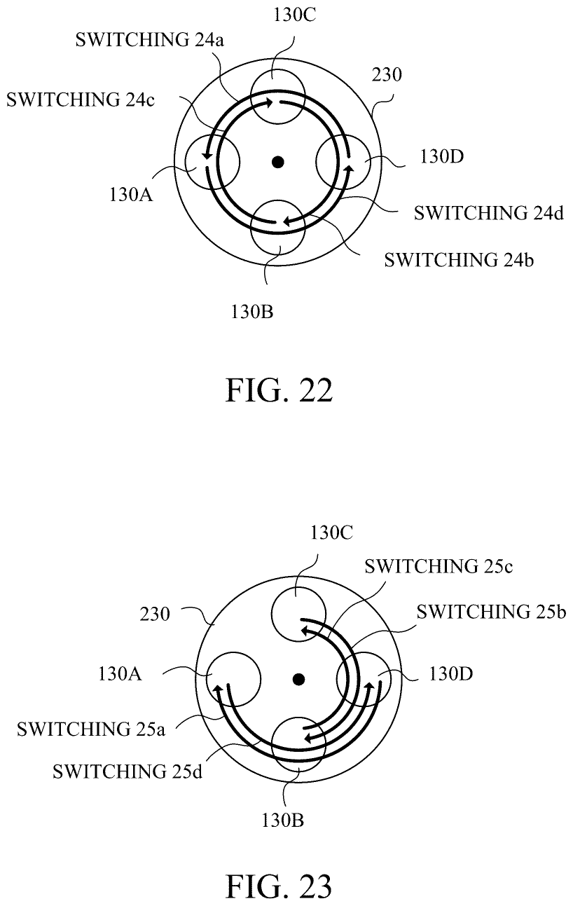

In step 727, the lens CPU 110 issues a control command to the turret driver 132 to switch to the desired optical area via an optical area with a smaller change in magnification. The turret driver 132 that has received the control command drives the turret 230. During this time, the lens CPU 110 detects the position of the turret 230 using the turret position detector 131, and in a case where it detects that the turret 230 has reached the desired position, it stops issuing the control command to the turret driver 132 and the flow ends. The switching operation at this time is schematically illustrated by switching 24a to switching 24d in FIG. 22. For example, in switching from the first optical area 130A to the fourth optical area 130D, the imaging magnification of the first optical area 130A is 1×, the imaging magnification of the second optical area 130B is 2×, and the imaging magnification of the third optical area 130C is 1×. Therefore, switching is performed to the fourth optical area 130D via the third optical area 130C, which has a small change in imaging magnification (switching 24a). Similarly, in switching from the second optical area 130B to the third optical area 130C, switching is performed to switch 24b. In switching from the third optical area 130C to the second optical area 130B, switching is performed to switch 24c, and in switching from the fourth optical area 130D to the first optical area 130A, switching is performed to switch 24d.

In step 728, the lens CPU 110 issues a control command to the turret driver 132 to switch to the target optical area via an optical area with a larger magnification. The turret driver 132 that has received the control command drives the turret 230. During that time, the lens CPU 110 detects the position of the turret 230 using the turret position detector 131, and in a case where it detects that the turret 230 has reached the desired position, it stops issuing the control command to the turret driver 132 and the flow ends. The switching operation at this time is schematically illustrated as the switching 25a to switching 25d in FIG. 23. For example, in switching from the first optical area 130A to the fourth optical area 130D, the imaging magnification of the second optical area 130B is 2×, and the imaging magnification of the third optical area 130C is 1×. Therefore, switching is performed to the fourth optical area 130D via the second optical area 130B, which has a larger magnification (switching 25a). Similarly, in switching from the second optical area 130B to the third optical area 130C, switching is performed to the switching 25b. In switching from the third optical area 130C to the second optical area 130B, the switching is performed to switching 25c, and in a case where switching from the fourth optical area 130D to the first optical area 130A, the switch is performed to switching 25d.

Step 724 is sub-processing in switching to the adjacent optical area on the turret 230. In this case, according to the current optical area and the user's operation, either the optical-area clockwise CW/CCW switching flowchart according to Example 5, the optical-characteristic switching flowchart according to this example, or the imaging-magnification switching flowchart according to this example is executed. Then, this flow ends.

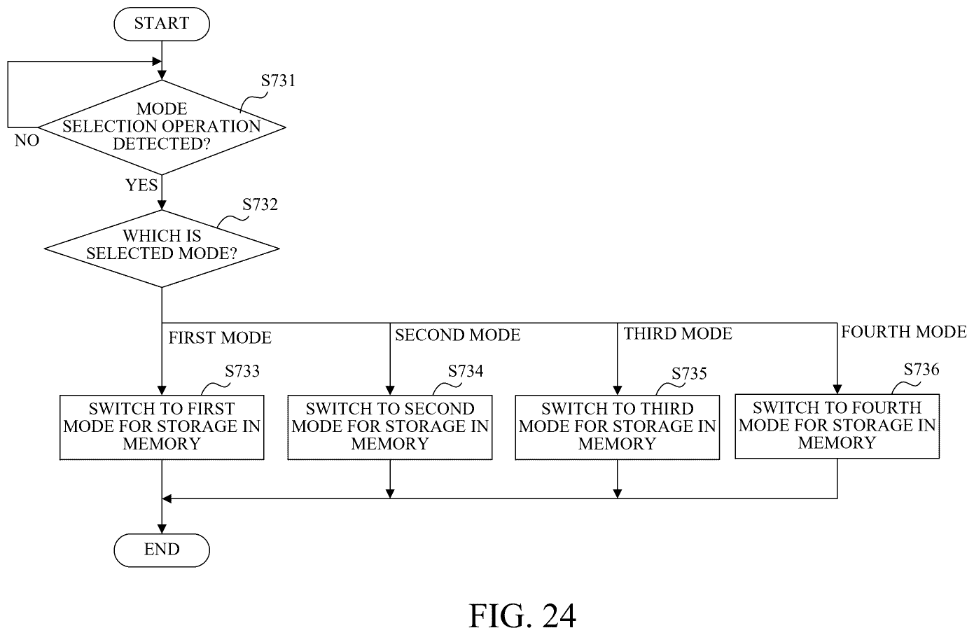

This time, in step 723, the mode selection detector 231 directly has detected the currently selected mode. This is not limited to this method, and for example, the mode selection detector 231 detects the mode selection by the user and stores the detection result in the memory 234. Then, in step 723, the stored mode may be read from the memory 234. FIG. 24 illustrates a mode setting flowchart using the memory 234 in the second embodiment.

In step 731, the mode selection detector 231 detects a mode selection operation by the user. In a case where no user operation is detected, the flow returns to step 731, and in a case where a user operation is detected, the flow proceeds to step 732.

In step 732, the lens CPU 110 determines the selected mode. In a case where the mode is the first mode, the flow proceeds to step 733, in a case where the mode is the second mode, the flow proceeds to step 734, in a case where the mode is the third mode, the flow proceeds to step 735, and in a case where the mode is the fourth mode, the flow proceeds to step 736.

In step 733, the lens CPU 110 changes the mode to be stored in the memory 234 to the first mode, and this flow ends.

In step 734, the lens CPU 110 changes the mode to be stored in the memory 234 to the second mode, and this flow ends.

In step 735, the lens CPU 110 changes the mode to be stored in the memory 234 to the third mode, and this flow ends.

In step 736, the lens CPU 110 changes the mode stored in the memory 234 to the fourth mode, and this flow ends.

Thereby, the switching flowchart according to this example in switching to the desired optical area via another optical area has been discussed.

Referring now to FIG. 25, a description will be given of the switching flowchart to the initial optical area used after the lens apparatus 200 according to this example is started. The initial optical area used after the lens apparatus 200 is started refers to any one of the first optical area 130A to the fourth optical area 130D that is disposed on the optical axis after the lens apparatus 200 is started. The purpose of this control is to improve the user's convenience after the lens apparatus 200 is started by controlling the switching to the initial optical area.

In step 741, the power detector 233 detects the user's power-on operation. In a case where the power-on operation is not detected, the flow returns to step 741, and in a case where it is detected, the flow proceeds to step 742. The power-on operation is detected here, but in order to reduce the processing the next time the power is turned on, a power-off operation may be detected and the following processing may be executed.

In step 742, the initial setting detector 232 detects the initial setting that is currently set. There are first to fourth initial settings.

The first initial setting is a setting to use the third optical area 130C as the initial optical area, which has a relatively wide angle due to an imaging magnification of 1× and has less spherical aberration than that of each of the first optical area 130A and the second optical area 130B, and therefore can capture a relatively sharp image.

The second initial setting is a setting to continue to use the optical area currently positioned on the optical axis as the initial optical area. For example, in a case where the optical area currently positioned on the optical axis is the first optical area 130A, the initial optical area at the next startup will also be the first optical area 130A. In a case where the optical area currently positioned on the optical axis is the second optical area 130B, the initial optical area at the next startup will also be the second optical area 130B.

The third initial setting is a setting to switch the imaging magnification from 2× to 1× without changing the current spherical aberration characteristic. For example, in a case where the optical area currently positioned on the optical axis is the second optical area 130B, the initial optical area at the next startup will be the first optical area 130A. In a case where the optical area currently positioned on the optical axis is the fourth optical area 130D, the initial optical area at the next startup will be the third optical area 130C. In a case where the optical area currently positioned on the optical axis is the first optical area 130A, the initial optical area at the next startup will remain the first optical area 130A.

The fourth initial setting is a setting in which the user can freely determine the initial optical area from among the first optical area 130A to the fourth optical area 130d.

In a case where the detected mode is the first initial setting, the flow proceeds to step 743, and in a case where the detected mode is the second initial setting, the optical area currently positioned on the optical axis continues to be used as the initial optical area, and this flow ends as it is. In a case where the detected mode is the third initial setting, the flow proceeds to step 744, and in a case where the detected mode is the fourth initial setting, the flow proceeds to step 747.

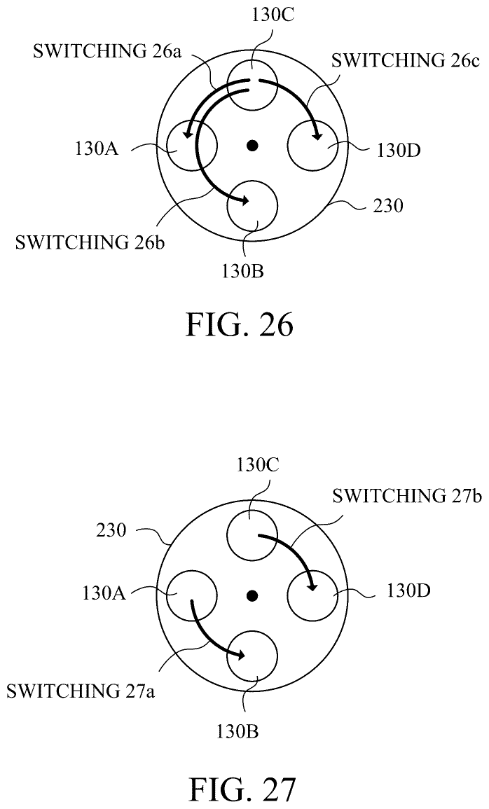

In step 743, the lens CPU 110 issues a control command to the turret driver 132 to switch to the third optical area 130C. The turret driver 132 that has received the control command drives the turret 230. During this time, the lens CPU 110 detects the position of the turret 230 using the turret position detector 131, and in a case where it detects that the turret 230 has reached the desired position, it stops issuing the control command to the turret driver 132 and this flow ends. The switching operation at this time is schematically illustrated as in switching 26a to switching 26c in FIG. 26. In other words, whether the optical area currently positioned on the optical axis is the first optical area 130A, the second optical area 130B, or the fourth optical area 130D, it is switched to the third optical area 130C.

In step 744, the lens CPU 110 determines which of the first optical area 130A to fourth optical area 130D is currently positioned on the optical axis. At this time, the lens CPU 110 may determine the optical area currently positioned on the optical axis using the turret position detector 131, or may store the optical area currently positioned on the optical axis in advance in the memory 234 and read the information from the memory 234 to make the determination. In a case where the optical area currently positioned on the optical axis is the second optical area 130B, the flow proceeds to step 745; in a case where it is the fourth optical area 130D, the flow proceeds to step 746; in a case where it is the first optical area 130A or the third optical area 130C, this flow ends.

In step 745, the lens CPU 110 issues a control command to the turret driver 132 to switch to the first optical area 130A. The turret driver 132 that has received the control command drives the turret 230. During this time, the lens CPU 110 detects the position of the turret 230 using the turret position detector 131, and in a case where it detects that the turret 230 has reached the desired position, it stops issuing the control command to the turret driver 132, and the flow ends. The switching operation at this time is schematically illustrated as switching 27a in FIG. 27. In other words, the imaging magnification is switched from 2× to 1× without changing the optical characteristic that intentionally produces spherical aberration.

In step 746, the lens CPU 110 issues a control command to the turret driver 132 to switch to the third optical area 130C. The turret driver 132 that has received the control command drives the turret 230. During this time, the lens CPU 110 detects the position of the turret 230 using the turret position detector 131, and in a case where it detects that the turret 230 has reached the desired position, it stops issuing the control command to the turret driver 132 and the flow ends. The switching operation at this time is schematically illustrated as switching 27b in FIG. 27. In other words, the imaging magnification is switched from 2× to 1× without changing the optical characteristic that suppresses spherical aberration.

In step 747, the initial setting detector 232 detects the initial optical element set by the user. In a case where the initial optical element set is the first optical area 130A, the flow proceeds to step 748. In a case where it is the second optical area 130B, the flow proceeds to step 749. In a case where it is the third optical area 130C, the flow proceeds to step 250. In a case where it is the fourth optical area 130D, the flow proceeds to step 251.

In step 748, the lens CPU 110 issues a control command to the turret driver 132 to switch to the first optical area 130A. The turret driver 132 that has received the control command drives the turret 230. During this time, the lens CPU 110 detects the position of the turret 230 using the turret position detector 131, and in a case where it detects that the turret 230 has reached the desired position, it stops issuing the control command to the turret driver 132 and the flow ends. In step 749, the lens CPU 110 issues a control command to the turret driver 132 to switch to the second optical area 130B. The rest is similar to step 748.

In step 750, the lens CPU 110 issues a control command to the turret driver 132 to switch to the third optical area 130C. The rest is similar to step 748.

In step 751, the lens CPU 110 issues a control command to the turret driver 132 to switch to the fourth optical area 130D. The rest is similar to step 748.

This time, in step 742, the initial setting was directly detected by the initial setting detector 232. This is not the only method, and for example, the initial setting may be detected by the initial setting detector 232 and the detection result may be stored in the memory 234. Then, in step 742, the stored initial setting may be read from the memory 234.

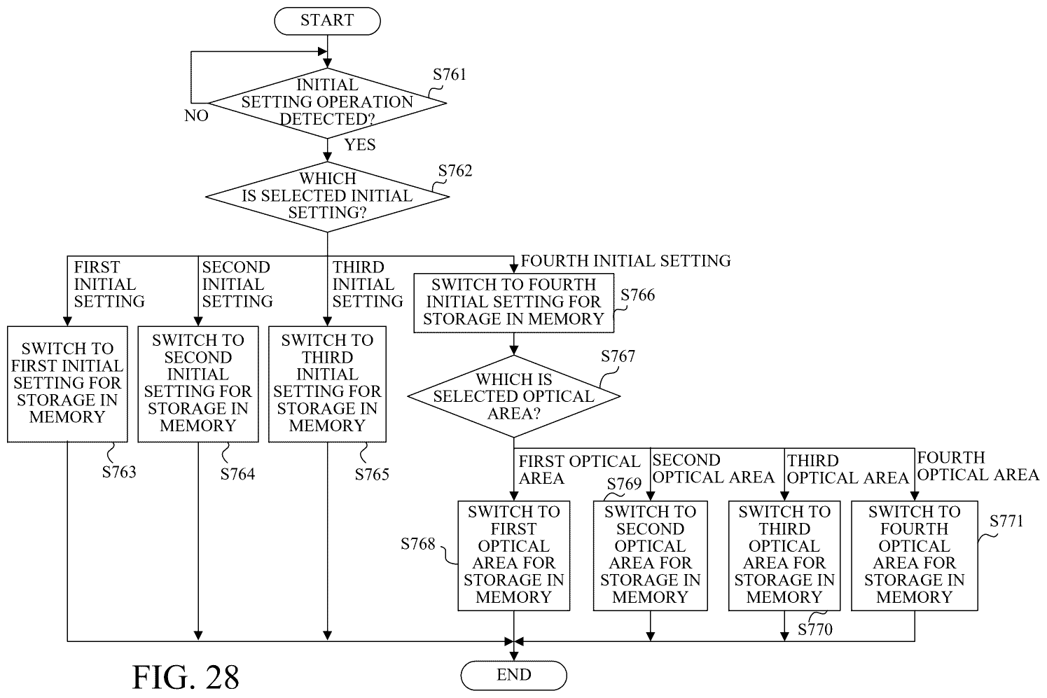

Similarly, in step 747, the initial setting detector 232 directly detected the initial optical area set by the user for the fourth initial setting. This method is not limited to the above, and for example, the initial optical area set by the user for the fourth initial setting may be detected by the initial setting detector 232, and the detection result may be stored in the memory 234. Then, in step 747, the initial optical area set by the user for the fourth initial setting that has been stored may be read from the memory 234. FIG. 28 illustrates an initial setting flowchart using the memory in this example.

In step 761, the initial setting operation by the user is detected by the initial setting detector 232. In a case where a user operation is not detected, the flow returns to step 761, and in a case where a user operation is detected, the flow proceeds to step 262.

In step 762, the lens CPU 110 determined the initial setting selected. In a case where it is the first initial setting, the flow proceeds to step 763. In a case where it is the second initial setting, the flow proceeds to step 764. In a case where it is the third initial setting, the flow proceeds to step 765. In a case where it is the fourth initial setting, the flow proceeds to step 766.

In step 763, the initial setting to be stored in the memory 234 by the lens CPU 110 is changed to the first initial setting, and this flow ends.

In step 764, the lens CPU 110 changes the initial setting to be stored in the memory 234 to the second initial setting, and this flow ends.

In step 765, the lens CPU 110 changes the initial setting to be stored in the memory 234 to the third initial setting, and this flow ends.

In step 766, the lens CPU 110 changes the initial setting to be stored in the memory 234 to the fourth initial setting, and the flow chart moves to step 767.

In step 767, the lens CPU 110 determines the initial optical area selected. In a case where it is the first optical area, the flow proceeds to step 768. In a case where it is the second optical area, the flow proceeds to step 769. In a case where it is the third optical area, the flow proceeds to step 770. In a case where it is the fourth optical area, the flow proceeds to step 771.

In step 768, the lens CPU 110 changes the initial optical area to be stored in the memory 234 to the first optical area, and this flow ends.

In step 769, the lens CPU 110 changes the initial optical area stored in the memory 234 to the second optical area, and this flow ends.

In step 270, the lens CPU 110 changes the initial optical area stored in the memory 234 to the third optical area, and this flow ends.

In step 271, the lens CPU 110 changes the initial optical area stored in the memory 234 to the fourth optical area, and this flow ends.

Thereby, the flowchart for switching to the initial optical area used after the lens apparatus 200 according to this example starts has been discussed.

### EXAMPLE 7

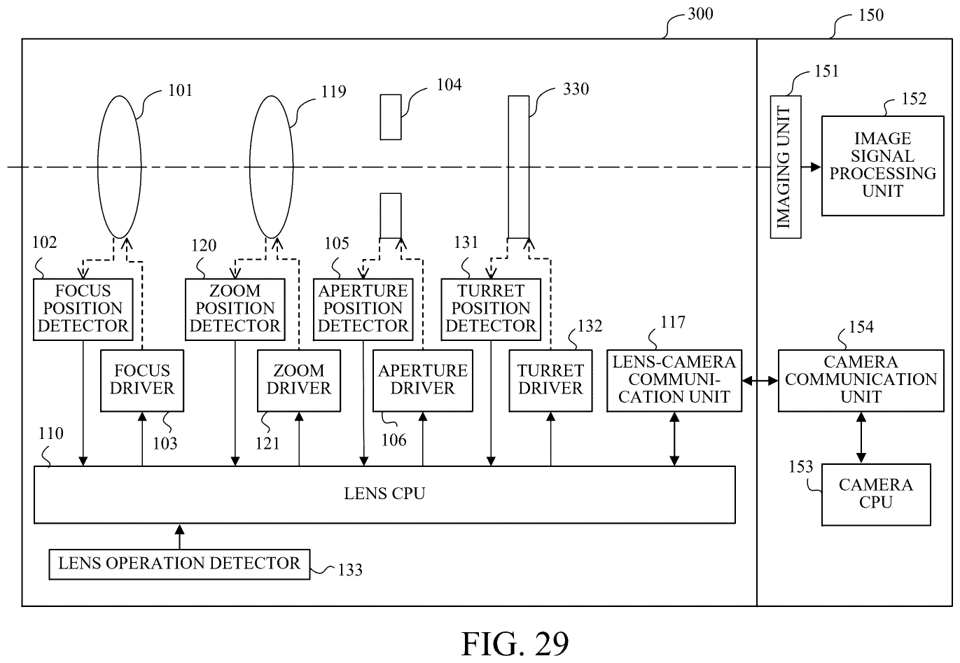

Referring now to FIG. 29, a description will be given of a configuration diagram of a camera system including an optical-area switching apparatus according to this example.

FIG. 29 is a configuration diagram of the camera system that includes a lens apparatus 300 including a turret 330 as the optical-area switching apparatus, and a camera apparatus 150. Those elements, which are corresponding elements in Example 5, will be designated by the same reference numerals, and a description thereof will be omitted.

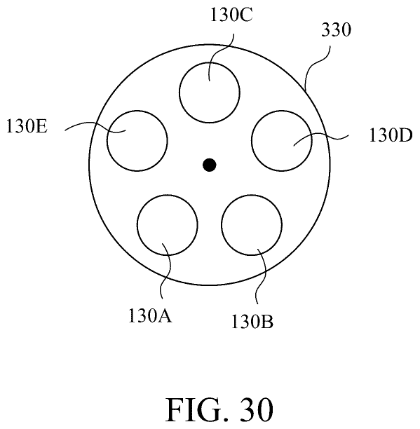

As illustrated in FIG. 30, the turret 330 has a first optical area 130A, a second optical area 130B, a third optical area 130C, a fourth optical area 130D, and a fifth optical area 110E arranged on a circumference. The fifth optical area 110E has the imaging magnification of 1× in the entire optical system and includes a color correction filter for color correction.

By using such an optical-area switching apparatus (turret 330), it is not necessary to align the filter switching turret and the magnification switching extender in the optical axis direction, so that an optical-area switching apparatus can have a reduced size in the optical axis direction.

Although the fifth optical area 110E includes a color correction filter, it may be an optical element having another optical characteristic, such as an ND filter for adjusting a light amount passing through the lens apparatus 300 or a visible light cut filter for cutting visible light.

The optical element referred to here is not limited to a single optical element, but may be a combination of multiple optical elements, for example a combination of an optical element for intentionally producing spherical aberration and an optical element for changing the imaging magnification in the entire optical system.

The turret driver 132 is a driver mechanically connected to the turret 330, and includes a known and publicly used driver circuit and motor in this example.

The turret position detector 131 is a position detector mechanically, magnetically, or optically connected to the turret 330, and includes a known and publicly used encoder for position detection in this example.

Thereby, the block diagram of the camera system including the optical-area switching apparatus according to this example has been discussed.

This example can use the optical-area CW/CCW switching flowchart illustrated in FIG. 12 in Example 1. The flowchart is the same, and thus a description thereof will be omitted.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

In a case where the plurality of optical units in the conventional configuration include optical units that have the same magnification but different optical properties other than the magnification, these optical units cannot be switched properly by simply specifying the magnification. On the other hand, each example according to the disclosure can provide a lens apparatus that can properly switch optical units.

This application claims the benefit of Japanese Patent Application No. 2024-156748, which was filed on Sep. 10, 2024, and Japanese Patent Application No. 2025-106204, which was filed on Jun. 24, 2025, which are hereby incorporated by reference herein in their entirety.

What is claimed is:

1. A lens apparatus comprising:
a plurality of optical areas configured to be selectively inserted into or removed from an optical path;
one or more processors that, upon execution of instructions, operate to:
acquire information on a plurality of optical characteristics corresponding to the plurality of optical areas, and
determine an optical area among the plurality of optical areas using the information; and
a driver configured to insert the determined optical area into the optical path.

2. The lens apparatus according to claim 1, wherein the information on the plurality of optical characteristics includes information on a magnification of the optical area.

3. The lens apparatus according to claim 1, wherein the information on the plurality of optical characteristics includes information on an aberration of the optical area.

4. The lens apparatus according to claim 3, wherein the aberration includes at least one of spherical aberration and chromatic aberration.

5. The lens apparatus according to claim 3, wherein the plurality of optical characteristics include a first optical characteristic and a second optical characteristic, and
wherein the plurality of optical areas include a first optical area and a second optical area, which have the same first optical characteristics and different second optical characteristics.

6. The lens apparatus according to claim 5, wherein the plurality of optical areas include at least one third optical area, the first optical characteristic of the at least one third optical area and the first optical characteristic of the first optical area are different, and the second optical characteristic of the at least one third optical area and the second optical characteristic of the first optical area are the same.

7. The lens apparatus according to claim 6, wherein the plurality of optical areas includes at least one fourth optical area, the first optical characteristic of the at least one fourth optical area and the first optical characteristic of the second optical area are different, and the second optical characteristic of the at least one fourth optical area and the second optical characteristic of the second optical area are the same.

8. The lens apparatus according to claim 1, further comprising a setting unit configured to set at least a part of the information on the plurality of optical characteristics.

9. The lens apparatus according to claim 1, wherein the plurality of optical characteristics include a first optical characteristic and a second optical characteristic, and
wherein the optical area to be inserted into the optical path has the first optical characteristic and the second optical characteristic, both of which are the same as those acquired by the one or more processors.

10. The lens apparatus according to claim 1, wherein the plurality of optical characteristics include a first optical characteristic and a second optical characteristic, and
wherein the optical area to be inserted into the optical path has the first optical characteristic and the second optical characteristic, only one of which is the same as a corresponding one of the first optical characteristic and the second optical characteristic acquired by the one or more processors.

11. The lens apparatus according to claim 1, wherein the plurality of optical characteristics include a first optical characteristic and a second optical characteristic,
wherein the plurality of optical areas include an optical area that has the first optical characteristic, which is the same as the first optical characteristic acquired by the one or more processors, and the second optical characteristic, which is different from the second optical characteristic acquired by the one or more processors, and
wherein the optical area to be inserted into the optical path has the first optical characteristic, which is different from the first optical characteristic acquired by the one or more processors.

12. The lens apparatus according to claim 1, further comprising a communication unit for communicating with an external device,
wherein the one or more processors operate to acquire at least a part of the information on the plurality of optical characteristics via the communication unit.

13. A lens apparatus comprising:
a plurality of optical areas configured to be selectively inserted into or removed from an optical path;
one or more processors that, upon execution of instructions, operate to:
acquire information on aberrations of the plurality of optical areas, and
determine an optical area among the plurality of optical areas using the information; and
a driver configured to insert the determined optical area into the optical path.

14. The lens apparatus according to claim 1, wherein the plurality of optical areas include:
first and second optical areas having the same optical characteristic and different imaging magnifications; and
third and fourth optical areas having different optical characteristics other than the imaging magnifications from those of the first and second optical areas and different imaging magnifications from each other.

15. A system comprising:
the lens apparatus according to claim 1; and
an external device communicable with the lens apparatus.

16. A lens apparatus comprising:
a plurality of optical areas configured to be selectively inserted into or removed from an optical path;
wherein the plurality of optical areas include:
first and second optical areas having the same optical characteristic and different imaging magnifications; and
third and fourth optical areas having different optical characteristics other than the imaging magnifications from those of the first and second optical areas and different imaging magnifications from each other.

17. The lens apparatus according to claim 16, wherein the first and second optical areas are arranged adjacent to each other.

18. The lens apparatus according to claim 17, wherein the third optical area is disposed adjacent to one of the first and second optical areas, which has an imaging magnification closer to that of the third optical area.

19. The lens apparatus according to claim 18, wherein each of the first and second optical areas has a spherical aberration characteristic different from that of each of the third and fourth optical areas,
wherein each of the first and third optical areas has an imaging magnification of 1 times in an entire optical system, and
wherein each of the second and fourth optical areas has an imaging magnification of 2 times in the entire optical system.

20. The lens apparatus according to claim 19, wherein each of the first and second optical areas has an optical characteristic that produces spherical aberration, and
wherein each of the third and fourth optical areas has an optical characteristic that suppresses spherical aberration.
